(19) United States
(12) Patent Application Publication
(10) Pub. No.: US 2011/0112740 A1
(43) Pub. Date: May 12, 2011

(54) CONTROL DEVICE FOR INTERNAL COMBUSTION ENGINE AND METHOD FOR CONTROLLING INTERNAL COMBUSTION ENGINE

(75) Inventor: Ikuro HASHIMOTO, Kariya-city (JP)

(73) Assignee: DENSO CORPORATION, Kariya-city (JP)

(21) Appl. No.: 12/914,013

(22) Filed: Oct. 28, 2010

(30) Foreign Application Priority Data
Nov. 11, 2009 (JP) 2009-257639
Nov. 24, 2009 (JP) 2009-265903
Nov. 30, 2009 (JP) 2009-271330

(51) Int. Cl. F02D 17/02; B60T 8/172

(52) U.S. Cl. 701/70; 701/112

(57) ABSTRACT

A control device performs an automatic stop operation and an automatic restart operation of an internal combustion engine of a vehicle having a steering device, which is manipulated by a driver to steer a steering wheel of the vehicle. A prohibition unit prohibits the automatic stop operation according to transition of a steering degree of the steering device when the vehicle travels.

### CROSS REFERENCE TO RELATED APPLICATIONS

This application is based on and incorporates herein by reference Japanese Patent Applications No. 2009-265903 filed on Nov. 24, 2009, No. 2009-257639 filed on Nov. 11, 2009, and No. 2009-271330 filed on Nov. 30, 2009.

### FIELD OF THE INVENTION

The present invention relates to a control device configured to perform an automatic stop operation and an automatic restart operation of an internal combustion engine of a vehicle having a steering device to steer a steering wheel of the vehicle. The present invention further relates to a control device configured to perform an operation to stop an internal combustion engine of a vehicle automatically while the vehicle travels. The present invention further relates to a control device for an internal combustion engine of an idle-stop vehicle configured to automatically stop the internal combustion engine before a speed of the vehicle becomes 0 when a brake pedal is depressed to reduce the vehicle speed while traveling at a low speed less than or equal to a predetermined vehicle speed. The present invention further relates to a method for controlling an internal combustion engine of a vehicle.

### BACKGROUND OF THE INVENTION

Conventionally, an idle stop control is employed to perform an automatic stop operation to stop an internal combustion engine automatically, when a predetermined stop condition is satisfied while the internal combustion engine is in operation, and a restart operation to restart the internal combustion engine when a predetermined restart condition is satisfied subsequent to the automatic stop operation. In this way, an idle stop control enables to cause a fuel consumption reduction effect of the internal combustion engine. For example, publication of Japanese patent application 2002-004909 (JP-A-2002-004909) discloses an idle stop control to prohibit an automatic stop operation according to a steering degree of a steering device. Specifically, in general, a steering degree of a steering device becomes large in a condition where a vehicle is required to start quickly after a temporary stop due to right or left turn in an intersection. In consideration of this, the present idle stop control prohibits the automatic stop operation when the steering degree becomes more than a predetermined degree. In this way, the present idle stop control maintains a drivability of the vehicle. Japanese patent publication 4176511 discloses an art to perform an idle stop control according to a steering degree of a steering device. It is noted that the present inventors have investigated that an intension of a driver to stop a vehicle is hard to be determined with high accuracy simply according to the steering degree of the steering device to prohibit an automatic stop operation. When an intension of a driver to stop a vehicle cannot be determined with high accuracy, automatic stop of the internal combustion engine may occur contrary to an intension of a driver.

Japanese patent publication 4096748 also discloses an idle stop control to stop an internal combustion engine automatically, when a predetermined stop condition is satisfied while the internal combustion engine is in an idling operation, and to restart the internal combustion engine when a predetermined restart condition is satisfied thereafter. In this way, an idle stop control enables to cause a fuel consumption reduction effect of the internal combustion engine. Japanese patent publication 4237132 discloses an art to permit automatic stop of an internal combustion engine even when a vehicle travels. In this way, an internal combustion engine is automatically stopped further frequently to enhance a fuel consumption reducing effect. When an art to permit automatic stop of an internal combustion engine, even when the vehicle is traveling, is employed, an internal combustion engine may be automatically stopped contrary to no intension of a driver to stop the vehicle while the vehicle travels. In this case, a driver may not be able to travel the vehicle appropriately, and consequently, drivability of the vehicle may be spoiled.

For example, publication of Japanese patent application 2000-199444 (JP-A-2000-199444) discloses an idle-stop vehicle configured to stop an internal combustion engine automatically in response to stop of a vehicle. Specifically, the idle-stop vehicle is configured to stop an internal combustion engine automatically on condition that a brake pedal is depressed, and a speed of the vehicle is 0. In recent years, in order to further reduce fuel consumption, a proposed control method includes stopping of an internal combustion engine automatically before a speed of the vehicle becomes 0, when a brake pedal is depressed by a degree greater than or equal to a threshold while the vehicle travels at a low speed.

It is noted that the proposed control method including stopping of the internal combustion engine automatically, when depression of a brake pedal is greater than or equal to a threshold while the vehicle travels at a low speed, may cause the following problem. Vehicles have different correlations each between depression of a brake pedal and speed reduction caused by the depression. Therefore, the same depression quantity of brake pedals causes different speed reduction of the vehicles. Thus, when the threshold for automatic stop is uniformly set for all vehicles, frequency of automatic stop may vary in vehicle. For example, one vehicle may cause automatic stop less frequently and another vehicle may cause automatic stop frequently. Specifically, one vehicle may not perform automatic stop of an internal combustion engine due to insufficient depression of a brake pedal contrary to an intension of a driver to stop the vehicle. In addition, another vehicle may perform automatic stop of an internal combustion engine even when a driver depresses a brake pedal to reduce a speed without an intension to stop the vehicle. In this case, determination whether to stop the vehicle automatically before the speed of the vehicle becomes zero (before stopping) cannot be made appropriately according to actual speed reduction caused by depression of a brake pedal in a specific vehicle. Consequently, a driver may feel uncomfortable.

### SUMMARY OF THE INVENTION

The present invention addresses the above disadvantage.

According to one aspect of the present invention, a control device for an internal combustion engine for a vehicle having a steering device for steering a steering wheel of the vehicle, the control device comprises a control unit configured to perform an automatic stop operation and a restart operation of the internal combustion engine. The control device further comprises a prohibition unit configured to prohibit the automatic stop operation according to transition of a steering degree of the steering device while the vehicle travels.

According to another aspect of the present invention, a control device for an internal combustion engine of a vehicle, the method comprises a control unit configured to perform an operation to stop the internal combustion engine automatically while the vehicle travels. The control device further comprises a vehicle braking force arithmetic unit configured to calculate a vehicle braking force, which is a resultant force of an acceleration force and a deceleration force, the acceleration force working in an acceleration direction to accelerate the vehicle, the deceleration force working in a deceleration direction to decelerate the vehicle, the deceleration force including a braking force of a brake device of the vehicle, the vehicle braking force has a positive value when working in the deceleration direction to decelerate the vehicle. The control device further comprises a prediction unit configured to predict whether the vehicle stops according to the calculated vehicle braking force and a traveling speed of the vehicle. The control unit is further configured to perform the operation to stop the internal combustion engine automatically according to a prediction that the vehicle stops.

According to another aspect of the present invention, a control device for an internal combustion engine of a vehicle, the vehicle configured to automatically stop the internal combustion engine before a speed of the vehicle becomes 0 when a brake pedal is depressed while the vehicle travels at a low speed less than or equal to a predetermined speed, the control device control device comprises a learning unit configured to: associate a depression quantity of a brake pedal of the vehicle and a speed of the vehicle at a time point, when the brake pedal is depressed while the vehicle travels at a low-speed, with a result whether the vehicle results in stop due to depression of the brake pedal; and learn the associated depression quantity and the speed with the result to obtain a learning result. The idle stop control device further comprises a determination unit configured to determine whether to stop the internal combustion engine automatically according to the learning result of the learning unit when the brake pedal is depressed while the vehicle travels at a low speed.

According to another aspect of the present invention, a method for controlling an internal combustion engine for a vehicle, the vehicle configured to perform an automatic stop operation and a restart operation of an internal combustion engine, the vehicle having a steering device for steering a steering wheel of the vehicle, the method comprises detecting a steering degree of the steering device. The method further comprises prohibiting the automatic stop operation according to a transition of the detected steering degree of the steering device while the vehicle travels.

According to another aspect of the present invention, a method for controlling an internal combustion engine of a vehicle, the method comprises calculating a vehicle braking force, which is a resultant force of an acceleration force and a deceleration force, the acceleration force working in an acceleration direction to accelerate the vehicle, the deceleration force working in a deceleration direction to decelerate the vehicle, the deceleration force including a braking force of a brake device of the vehicle, the vehicle braking force having a positive value when working in the deceleration direction. The method further comprises predicting whether the vehicle stops according to the calculated vehicle braking force and a traveling speed of the vehicle. The method further comprises stopping the internal combustion engine automatically while the vehicle travels according to a prediction that the vehicle stops.

According to another aspect of the present invention, a method for controlling an internal combustion engine of a vehicle, the method comprises associating a depression quantity of a brake pedal of the vehicle and a speed of the vehicle at a time point, when the brake pedal is depressed while the vehicle travels at a low-speed, with a result whether the vehicle results in stop due to depression of the brake pedal. The method further comprises learning the associated depression quantity and the speed with the result to obtain a learning result. The method further comprises determining whether to stop the internal combustion engine automatically, when the brake pedal is depressed while the vehicle travels at a low speed less than or equal to a predetermined speed, according to the learning result to obtain a determination result. The method further comprises stopping the internal combustion engine automatically before the speed becomes 0, according to the determination result.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a system configuration according to a first embodiment;

FIG. 2 is a view showing calculation of a vehicle direction change angle according to the first embodiment;

FIG. 3 is a view showing a traveling pattern of a vehicle according to the first embodiment;

FIG. 4 is a flow chart showing an idle stop control operation according to the first embodiment;

FIG. 5 is a time chart showing the idle stop control operation according to the first embodiment;

FIG. 6 is a flow chart showing an idle stop control operation according to a second embodiment;

FIG. 7 is a time chart showing the idle stop control operation according to the second embodiment;

FIG. 8 is a flow chart showing an idle stop control operation according to a third embodiment;

FIG. 9 is a time chart showing the idle stop control operation according to the third embodiment;

FIG. 10 is a schematic view showing a system configuration according to a fourth embodiment;

FIG. 11 is an explanatory view of an engine stop condition according to the fourth embodiment;

FIG. 12 is an explanatory view of an engine restart condition according to the fourth embodiment;

FIG. 13 is a flow chart showing an idle stop control operation according to the fourth embodiment;

FIG. 14 is an explanatory view of an automatic stop regulating operation according to the fourth embodiment;

FIG. 15 is a time chart showing a restart regulating operation according to the fourth embodiment;

FIG. 16 is a schematic view showing an idle-stop vehicle provided with an idle stop control device according to a fifth embodiment;

FIG. 17 is a time chart showing a time point t1, at which a brake device is operated first after the vehicle shifts to a low-speed traveling state, and a time point t2, at which the vehicle stops;

FIG. 18 is a data map storing a learning result to be used for determination whether to perform automatic engine stop, according to the fifth embodiment; and

FIG. 19 is a flow chart showing a learning operation and an automatic stop operation according to the fifth embodiment.

### DETAILED DESCRIPTION OF PREFERRED EMBODIMENTS

### First Embodiment

As follows, a first embodiment of a control unit for an internal combustion engine will be described with reference to drawings.

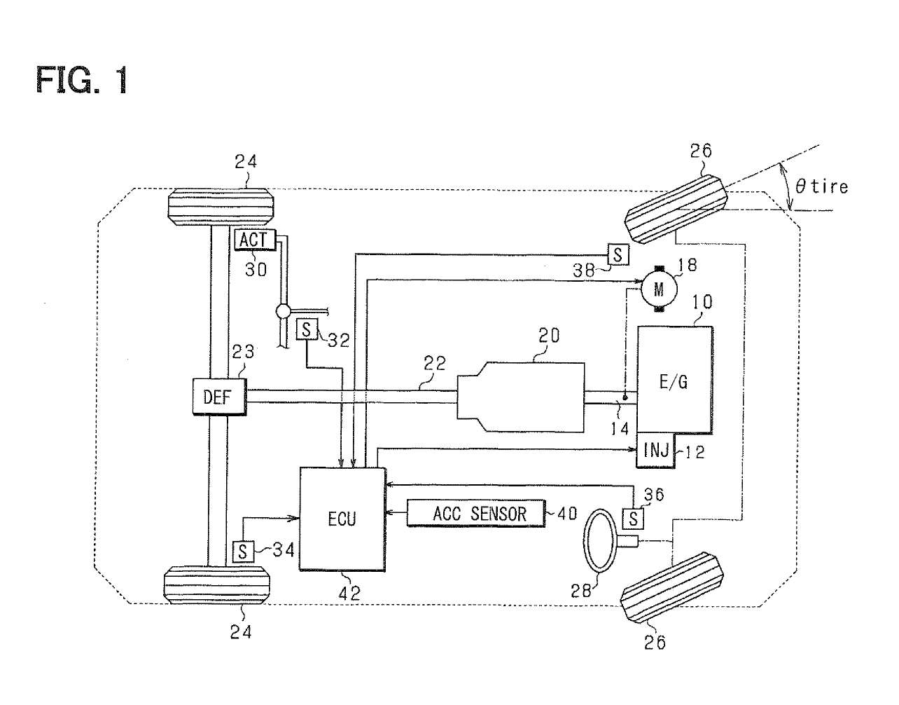

FIG. 1 shows a system configuration according to the present embodiment.

An engine 10 has cylinders each provided with a fuel injection valve 12 for injecting fuel into a combustion chamber of the engine 10. Air-fuel mixture of injected fuel and intake air is burned to generate energy, and the generated energy causes a rotation energy of an output shaft (crankshaft 14) of the engine 10.

A starter 18 is connected to the crankshaft 14. The starter 18 is put into operation in response to activation of a starter switch to start a cranking operation so as to add initial rotation to the crankshaft 14 in order to start the engine 10.

Rotation energy of the crankshaft 14 is transmitted to a transmission device 20. The transmission device 20 converts rotation speed of the crankshaft 14 into rotation speed of an output shaft 22 according to a change gear ratio of the transmission device 20. Rotation energy of the output shaft 22 is transmitted to driving wheels 24 via a deferential gear 23.

A handle 28 is provided in a vehicle interior for operating steering wheels 26 (operational front wheels). A steering angle θtire of the steering wheels 26 is specified according to a steering degree of the steering handle 28.

A brake actuator 30 is provided near each of the driving wheels 24 and the steering wheels 26 (wheel) to exert a braking force to the wheels according to depression of a brake pedal. In FIG. 1, only one brake actuator 30 provided to the rear wheel on the left side is illustrated. Specifically, as depression of the brake pedal increases, a hydraulic pressure (brake hydraulic pressure) in a hydraulic pressure system of the brake device becomes large. Thereby, the braking force exerted by the brake actuator 30 to each wheel becomes large. The hydraulic pressure system of the brake device is provided with a brake hydraulic pressure sensor 32 for obtaining a brake hydraulic pressure by detecting, for example, a master cylinder pressure. A wheel speed sensor 34 is provided near each wheel for detecting a traveling speed of the vehicle. FIG. 1 illustrates only one wheel speed sensor 34 provided to the rear wheel on the right side.

An electronic control unit (ECU) 42 inputs various output signals from a steering handle sensor 36 for detecting operation of the steering handle (steering wheel) 28, a steering angle sensor 38 for detecting a steering angle of the steering wheel 26, an accelerator sensor 40 for detecting depression of an accelerator pedal, the brake hydraulic pressure sensor 32, the wheel speed sensor 34, and the like.

The ECU 42 has a generally known microcomputer including a CPU, a ROM, a RAM, and the like, as a main unit. The ECU 42 executes various kinds of control programs stored in the ROM according to the input signals from the sensors. Thereby, the ECU 42 performs a fuel injection control to operate the fuel injection valve 12, a starting control to operate the starter 18, and the like.

In particular, the ECU 42 performs an idle stop control of the engine 10. The idle stop control includes an automatic stop operation to stop the engine 10 automatically, when a predetermined stop condition is satisfied, and a restart operation to restart the engine 10 when a predetermined restart condition is satisfied subsequent to the automatic stop operation. In this way, a fuel consumption reducing effect of the engine 10 can be achieved. In the present embodiment, in order to enhance a fuel consumption reducing effect further by the idle stop control, the automatic stop operation is permitted even when the vehicle is traveling.

Subsequently, an automatic stop prohibiting operation to prohibit the automatic stop operation according to the present embodiment will be described.

The automatic stop prohibiting operation is performed to maintain drivability of the vehicle. For example, when the vehicle is traveling, a driver may manipulate the steering handle 28 to approach (pull over) the vehicle toward a road shoulder in order to stop the vehicle. In this case, when the stop condition is satisfied and when the automatic stop operation of the engine 10 is performed to stop the engine 10, the driver may not drive the vehicle appropriately. Consequently, drivability of the vehicle may be spoiled. Therefore, the automatic stop prohibiting operation is performed in an operation region (automatic stop prohibition region), such as pull over of the vehicle, where a driver does not desire automatic stop of the engine 10. Thereby, drivability of the vehicle is maintained. As follows, definition of the automatic stop prohibition region according to the present embodiment will be described in detail.

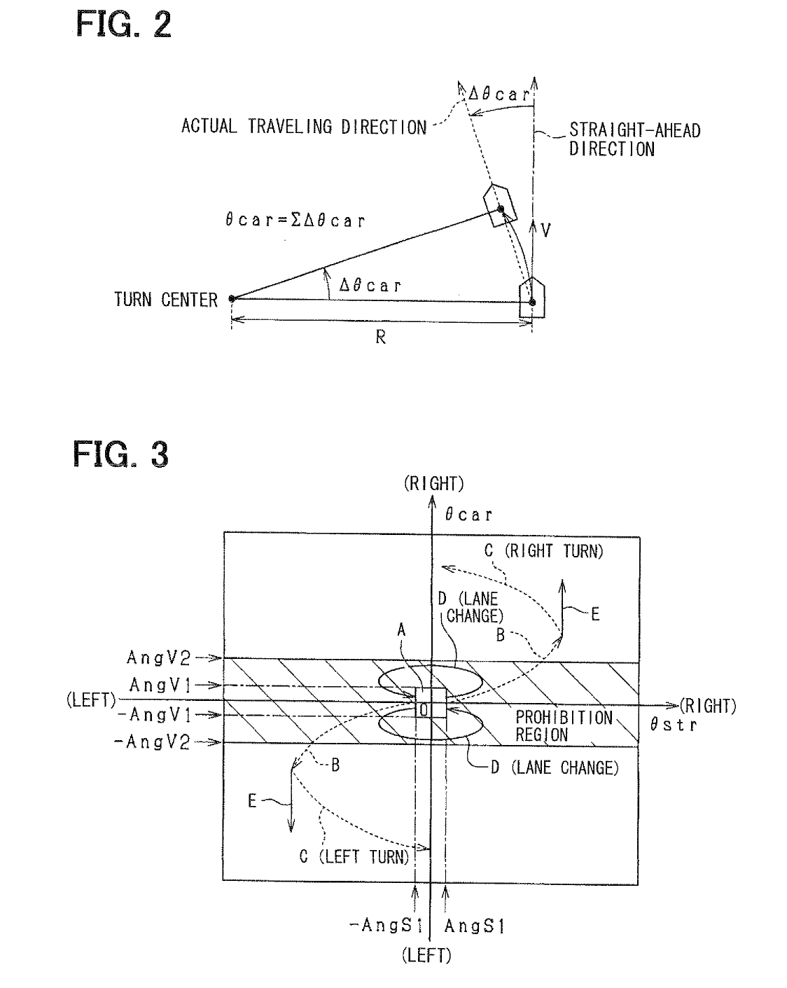

In the present embodiment, as shown in FIG. 2, a vehicle direction change angle θcar is employed as a parameter for defining the automatic stop prohibition region. The vehicle direction change angle θcar is a parameter for quantifying an angle between a straight-ahead direction of the vehicle and an actual traveling direction of the vehicle. The vehicle direction change angle θcar is an integration value of a value of the angle between the going-straight direction (dashed dotted line) of the vehicle and the actual traveling direction (dashed line) of the vehicle at each time when the vehicle is traveling.

In the present embodiment, an angular change Δθcar is used as a change rate (angular velocity) of the angle in calculating of the vehicle direction change angle θcar. The angular change Δθcar is quantified by a value of (180×V)/(π×R) [deg/time] calculated by dividing the traveling speed V of the vehicle by the turning radius R of the vehicle. The π is the circular constant. The vehicle direction change angle θcar is calculated as a time integration value of the angular change Δθcar. The turning radius R of the vehicle corresponds to the wheel angle of the steering wheel 26. The turning radius R may be calculated from, for example, a steering degree of the steering handle 28, which is obtained from an output signal of the steering handle sensor 36, and the wheelbase of the vehicle. Alternatively, the turning radius R may be calculated from the wheel angle of the steering wheel 26, which is obtained from an output signal of the angle sensor 38, and the wheelbase of the vehicle. The traveling speed V of the vehicle may be calculated from an output signal of the wheel speed sensor 34.

In the present embodiment, the positive and negative sign (plus and minus) of the angular change Δθcar when the vehicle is turned rightward relative to an actual traveling direction of the vehicle is inverse of the positive and negative sign of the angular change Δθcar when the vehicle is turned leftward relative to the actual traveling direction of the vehicle. Specifically, a steering degree of the steering handle 28 when the vehicle travels straight ahead is set as a reference (0). In addition, the steering degree of the steering handle 28 and the angular change Δθcar when the vehicle turns rightward relative to the reference (0) has a positive value. Therefore, when the steering degree θstr of the steering handle 28 or the wheel angle θtire becomes greater than zero while the vehicle is traveling, the angular change Δθcar has a positive value. Thereby, the vehicle direction change angle θcar increases. Contrary, when the steering degree θstr of the steering handle 28 or the wheel angle θtire becomes less than zero while the vehicle is traveling, the angular change Δθcar has a negative value. Thereby, the vehicle direction change angle θcar decreases.

FIG. 3 shows a traveling pattern of the vehicle associated with the steering degree θstr of the steering handle 28 and the vehicle direction change angle θcar. In FIG. 3, the horizontal axis shows the steering degree θstr of the steering handle 28, and the vertical axis shows the vehicle direction change angle θcar.

(A) Straight Traveling Pattern:

The present straight traveling pattern is supposed when the driver travels the vehicle straight ahead. Specifically, the steering degree θstr of the steering handle 28 is substantially set to 0 in the straight traveling pattern. Thereby, the angular change Δθcar is substantially set to 0. Therefore, the vehicle direction change angle θcar becomes substantially 0. In the present embodiment, when an absolute value of the steering degree θstr of the steering handle 28 is less than a predetermined steering degree AngS1 (>0) and when an absolute value of the vehicle direction change angle θcar is less than a first predetermined angle AngV1 (>0), the traveling pattern of the vehicle is supposed to be in the straight traveling pattern.

(B) Right and Left Turn Start Pattern:

The present right and left turn start pattern is supposed when the vehicle is turning rightward or leftward at an intersection and waiting for an oncoming vehicle. Alternatively, the right and left turn start pattern is supposed immediately after starting of turning rightward or leftward. Specifically, since the vehicle is turned in the right and left turn start pattern, the absolute value of the steering degree θstr of the steering handle 28 is greater than the value in the straight traveling pattern. However, the vehicle direction change angle θcar does not become excessively large, since it is immediately after starting of turning the vehicle. Supposing that the engine 10 is automatically stopped in the right and left turn start pattern, the vehicle cannot be quickly started after waiting for an oncoming vehicle, or the vehicle cannot be appropriately turned as desired by the driver, for example. Consequently, drivability of the vehicle may be spoiled. In the present embodiment, when the steering degree θstr of the steering handle 28 is greater than the predetermined steering degree AngS1 and when the absolute value of the vehicle direction change angle θcar is less than a second predetermined angle AngV2, the traveling pattern of the vehicle is supposed to be in the right and left turn start pattern. The second predetermined angle AngV2 is greater than the first predetermined angle AngV1 (AngV2>AngV1).

(C) Right and Left Turn Completion Pattern:

The present right and left turn completion pattern is supposed after the vehicle completes turning rightward or leftward in the right and left turn start pattern and before the vehicle starts traveling along a traveling lane. Specifically, in the present right and left turn completion pattern, the steering handle 28 is manipulated so that the steering degree θstr, which is increased to be greater or less than 0 in the right and left turn start pattern, becomes 0. Thereby, the absolute value of the vehicle direction change angle θcar is converged to a value greater than the second predetermined angle AngV2.

(D) Lane Change Pattern:

The present lane change pattern is supposed when the vehicle changes lanes or the driver performs pull over of the vehicle. Specifically, in the lane change pattern, the steering degree θstr of the steering handle 28 is first increased or decreased from substantially 0. Thereby, the angular change Δθcar becomes a positive value or a negative value, and the vehicle direction change angle θcar starts increasing or decreasing from 0. Presently, the traveling direction of the vehicle starts changing rightward or leftward. Subsequently, the steering handle 28 is cut back to decrease or increase the steering degree θstr of the steering handle 28 to be less than or greater than 0. Thereby, the positive and negative sign of the angular change Δθcar is inverted to start decreasing or increasing of the vehicle direction change angle θcar. Presently, the traveling direction of the vehicle starts returning to the previous direction before the change in the traveling direction. The steering handle 28 is again cut back to decrease the steering degree θstr of the steering handle 28 to substantially 0. Thereby, the vehicle direction change angle θcar converges to substantially 0. Presently, the steering degree θstr of the steering handle 28 greatly changes. Contrary, the absolute value of the vehicle direction change angle θcar does not become great excessively. When the engine 10 is automatically stopped in the lane change pattern, the driver may be incapable of performing pull over of the vehicle appropriately. Consequently, the drivability of the vehicle may be spoiled. In the present embodiment, when the steering degree θstr of the steering handle 28 is greater than the predetermined steering degree AngS1 and when the absolute value of the vehicle direction change angle θcar is equal to or less than the second predetermined angle AngV2, the traveling pattern of the vehicle is supposed to be in the lane change pattern. Alternatively, when the steering degree θstr of the steering handle 28 is greater than the predetermined steering degree AngS1 and when the vehicle direction change angle θcar is greater than the first predetermined angle AngV1 and is equal to or less than the second predetermined angle AngV2, the traveling pattern of the vehicle is supposed to be in the lane change pattern.

(E) Static Cycle Turn Pattern:

The present static cycle turn pattern is supposed when the vehicle turns while maintaining a turning radius of the vehicle at a substantially constant radius. Specifically, the static cycle turn pattern is supposed when the vehicle travels in a rotary road or a runabout road. The runabout road is a circular road having intersections connected with multiple branch roads and mainly seen in Europe region. In the static cycle turn pattern, the steering handle 28 is manipulated so that the absolute value of the steering degree θstr is maintained at a substantially constant value. Thereby, the vehicle direction change angle θcar increases.

As described above, the vehicle direction change angle θcar and the steering degree θstr of the steering handle 28 are different in each traveling pattern of the vehicle caused by a driver. In this way, the traveling patterns (B) and (D), in which drivability of the vehicle may be spoiled due to the specific steering degree θstr and the specific vehicle direction change angle θcar, can be specified. Therefore, in the present embodiment, the traveling patterns (B) and (D) are assigned as automatic stop prohibition regions. Specifically, as shown by the hatched area in FIG. 3, the automatic stop prohibition region is assigned in consideration that the absolute value of the vehicle direction change angle θcar does not excessively increase in these traveling patterns (B) and (D). Thus, the automatic stop prohibition region is assigned in an operation region, in which the absolute value of the vehicle direction change angle θcar becomes less than the second predetermined angle AngV2, excluding the straight traveling pattern.

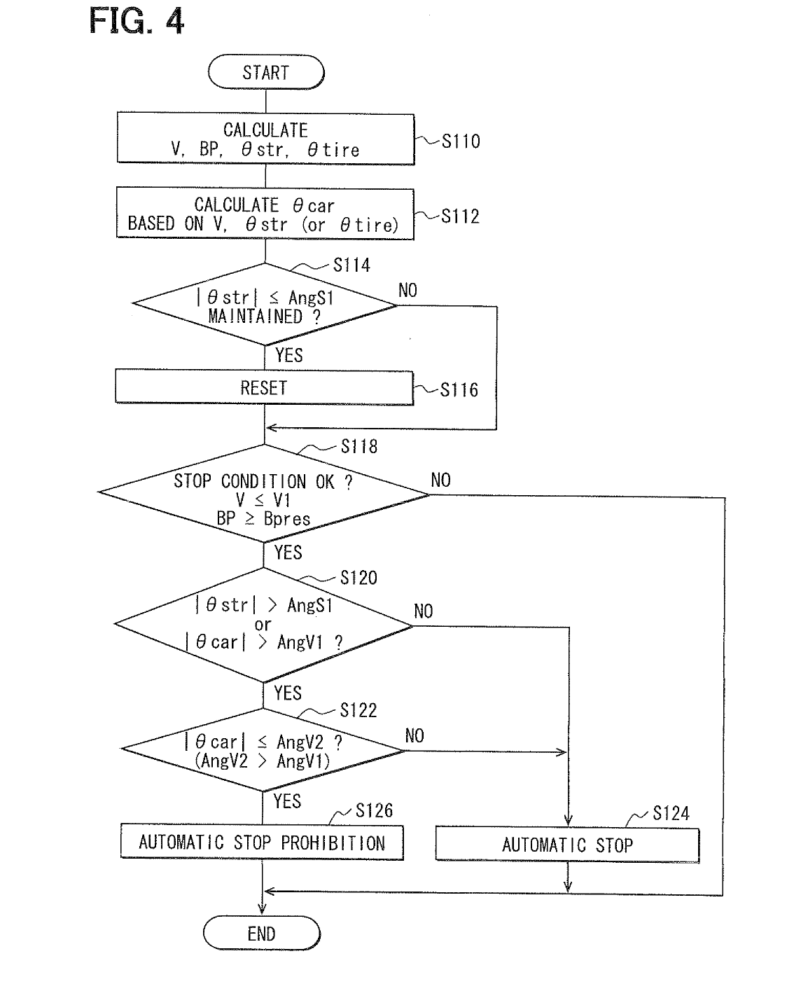

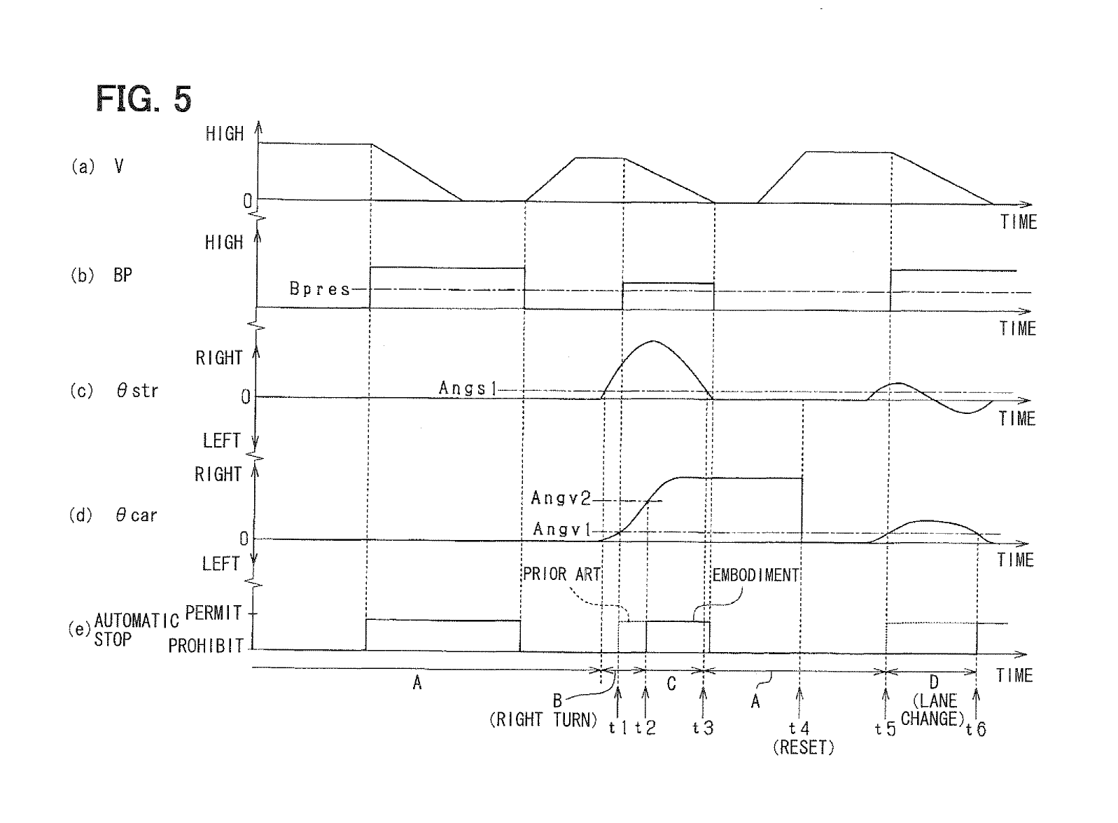

FIG. 4 shows a procedure of an idle stop control operation including the automatic stop prohibiting operation according to the present embodiment. The ECU 42 repeats the processing shown in FIG. 4 at, for example, a predetermined cycle during operation of the engine 10.

At step S110 of the series of processings, the ECU 42 first calculates the traveling speed V of the vehicle, the brake hydraulic pressure BP, the steering degree θstr of the steering handle 28, and the wheel angle θtire of the steering wheel 26. The brake hydraulic pressure BP may be calculated according to an output signal of the brake hydraulic pressure sensor 32.

At subsequent step S112, the vehicle direction change angle θcar is calculated according to the parameters calculated in the above processings.

At subsequent step S114, it is determined whether the absolute value of the steering degree θstr of the steering handle 28 is maintained less than or equal to the predetermined steering degree AngS during a time period in which the vehicle travels for a predetermined distance. The present processing is performed for determining whether the traveling pattern of the vehicle shifts to the straight traveling pattern. The present determination is made on the basis that the absolute value of the steering degree θstr of the steering handle 28 is in general maintained small for a certain time period when the traveling pattern of the vehicle shifts to the straight traveling pattern.

When it is determined that the traveling pattern shifts to the straight traveling pattern at step S114, the processing proceeds to step S116. At step S116, the ECU 42 performs a reset operation of the vehicle direction change angle θcar to set the vehicle direction change angle θcar to 0. The present processing is performed to avoid decreasing in accuracy of the present traveling pattern of the vehicle. For example, when the traveling pattern of the vehicle shifts from the right and left turn completion pattern to the straight traveling pattern, the ECU 42 maintains the previous value of the vehicle direction change angle θcar before the shifting of the traveling pattern, without the present processing. Therefore, the ECU 42 cannot obtain the present traveling pattern of the vehicle appropriately in a certain condition according to the vehicle direction change angle θcar calculated on the basis of the previous value of the vehicle direction change angle θcar before the shifting of the traveling pattern.

When step S114 makes a negative determination or when the operation of step S116 is completed, the processing proceeds to step S118. At step S118, it is determined whether a stop condition of the engine 10 is satisfied. In the present embodiment, the stop condition of the engine 10 is satisfied when the brake device is operated and when the traveling speed V of the vehicle becomes less than or equal to a specified speed V1 (for example, 15 km/h) higher than 0 km/h. Determination whether the brake device is operated may be made by determining whether the brake hydraulic pressure BP is greater than or equal to a predetermined hydraulic pressure Bpres.

When it is determined that the stop condition of the engine 10 is satisfied at step S118, the processing proceeds to S120. At step S120 and S122, it is determined whether the present operation region is the automatic stop prohibition region. Specifically, at step S120, it is first determined whether an absolute value of the steering degree θstr of the steering handle 28 is greater than the predetermined steering degree AngS1 and whether an absolute value of the vehicle direction change angle θcar is greater than the first predetermined angle AngV1.

When step S120 makes positive determinations, the processing proceeds to step S122. At step S122, it is determined whether an absolute value of the vehicle direction change angle θcar is less than or equal to the second predetermined angle AngV2.

When both steps S120 and S122 make negative determinations, it is determined that the present operation region is not an automatic stop prohibition region. In this case, at step S124, the automatic stop operation of the engine 10 is performed. The automatic stop operation is performed to stop the engine 10 by terminating fuel injection from the fuel injection valve 12.

When step S122 makes a positive determination, it is determined that the present operation region is the automatic stop prohibition region. In this case, at step S126, the automatic stop prohibiting operation of the engine 10 is performed.

When step S118 makes a negative determination or when the operation of steps S124 or S126 is completed, the series of processings are terminated.

FIG. 5 shows an example of the automatic stop prohibiting operation according to the present embodiment. In FIG. 5, a chart (a) shows transition of the traveling speed V of the vehicle, a chart (b) shows transition of the brake hydraulic pressure BP, a chart (c) shows transition of the steering degree θstr of the steering handle 28, a chart (d) shows transition of the vehicle direction change angle θcar, and a chart (e) shows activation and deactivation of the automatic stop prohibiting operation. In the example shown in FIG. 5, a condition of the traveling speed V of the vehicle is satisfied before the time t1. The condition of the traveling speed V is one of the stop conditions of the engine 10.

As shown in the FIG. 5, at the time t1 after the traveling pattern of the vehicle shifts from the straight traveling pattern to the right and left turn start pattern, it is determined that the brake operation is made to satisfy the stop condition of the engine 10. Nevertheless, the present operation region is determined to be the automatic stop prohibition region in the time period between the time t1 and the time t2. Thereby, the automatic stop prohibiting operation is performed. Consequently, the automatic stop operation is started at the time t2. Thereafter, it is determined that the steering degree θstr of the steering handle 28 is continually less that the predetermined steering degree AngS from the time t3, at which it is determined that the traveling pattern of the vehicle shifts, to the time t4, at which the vehicle completes traveling for a predetermined distance. Therefore, at the time t4, the reset operation is performed. Thereafter, the stop condition is satisfied at the time t5 when the traveling pattern of the vehicle shifts from the straight traveling pattern to the lane change pattern. Nevertheless, in the time period between the times t5 and t6, it is determined that the present operation region is an automatic stop prohibition region. Therefore, the automatic stop prohibiting operation is performed.

On the contrary, in the prior art, the automatic stop operation is permitted in the time period between the times t1 and t2 in which the traveling pattern of the vehicle is the right and left turn start pattern or in the time period between the times t5 and t6 in which the traveling pattern of the vehicle is the lane change pattern. Therefore, regardless of intension of a driver, automatic stop of the engine 10 occurs while the vehicle is traveling, and consequently drivability is spoiled.

As described above, in the present embodiment, the automatic stop prohibiting operation is performed in the automatic stop prohibition region to restrain automatic stop of the engine 10 contrary to an intension of a driver.

According to the present embodiment as described above, the following effects can be produced.

(1) The automatic stop prohibition region is associated with the steering degree θstr of the steering handle 28 and the vehicle direction change angle θcar, and the automatic stop prohibiting operation is performed in the automatic stop prohibition region. In this way, automatic stop of the engine 10 contrary to an intension of a driver can be restrained to enable maintaining of drivability of the vehicle suitably.

(2) The angular change Δθcar is calculated according to the traveling speed V of the vehicle and the steering degree θstr of the steering handle 28 or the wheel angle θtire of the steering wheel 26. In addition, the vehicle direction change angle θcar is calculated as a time integration value of the angular change Δθcar. In this way, the vehicle direction change angle θcar can be appropriately calculated.

(3) The reset operation is performed when it is determined that the absolute value of the steering degree θstr of the steering handle 28 is continually less than or equal to the predetermined steering degree AngS in the time period in which the vehicle travels for a predetermined distance subsequent to determination that the traveling pattern of the vehicle shifts to the straight traveling pattern. In this way, the present traveling pattern of the vehicle can be obtained with high accuracy.

### Second Embodiment

Hereafter, difference of the present second embodiment from the first embodiment will be described with reference to drawings.

In the present embodiment, the automatic stop prohibiting operation is performed in a condition where it is supposed that the time period (automatic stop time period) in which the engine 10 is automatically stopped is small. The present operation is performed to maintain reduction effect of fuel consumption. Specifically, when the vehicle is stopped to wait for an oncoming vehicle while turning rightward or leftward in an intersection, quick start of the vehicle is required after temporary stop. Alternatively, supposing that the vehicle is stopped to wait for a pedestrian crossing a crosswalk after the vehicle turns, quick start of the vehicle is also required after temporary stop in a predetermined time period after the vehicle completes turning before the vehicle starts traveling straight ahead. When the automatic stop operation is performed under such conditions, an automatic stop time period becomes small. Consequently, reduction in fuel consumption caused by automatically stopping the engine 10 is spoiled. Specifically, fuel injection quantity is so increased in a predetermined time period immediately after restart of the engine 10 as to quickly start the engine 10. Therefore, fuel quantity to restart the engine 10 may be greater than reduction in fuel consumption caused by automatic stop of the engine 10. Consequently, reduction effect of fuel consumption may be spoiled.

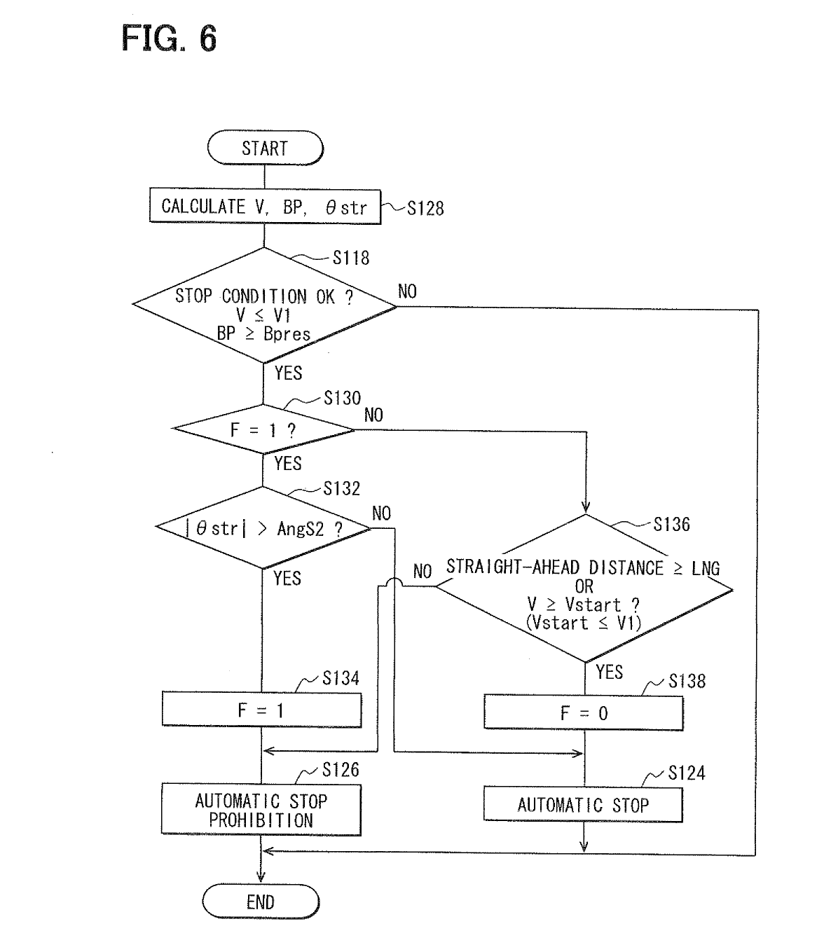

FIG. 6 shows a procedure of an idle stop control operation including the automatic stop prohibiting operation according to the present embodiment. The ECU 42 repeats the processing shown in FIG. 6 at, for example, a predetermined cycle during operation of the engine 10. In FIG. 6, the same reference numerals are denoted to equivalent steps in FIG. 4.

At step S128 of the series of processings, the ECU 42 first calculates the traveling speed V of the vehicle, the brake hydraulic pressure BP, and the steering degree θstr of the steering handle 28. At subsequent step S118, it is determined whether a stop condition of the engine 10 is satisfied.

When it is determined that the stop condition of the engine 10 is satisfied at step S118, the processing proceeds to S130. At step S130, it is determined whether an automatic stop prohibition flag F is set to 1. When the automatic stop prohibition flag F is set to 0, automatic stop of the engine 10 is not prohibited. Alternatively, when the automatic stop prohibition flag F is set to 0, automatic stop of the engine 10 is prohibited.

When it is determined that the automatic stop prohibition flag F is set to 0 at step S130, the processing proceeds to step S132. At step S132, it is determined whether an absolute value of the steering degree θstr of the steering handle 28 is greater than a predetermined degree AngS2 (>AngS1). The present processing is performed to determine whether the vehicle is turning in a condition where it is supposed that the automatic stop time period is small. Specifically, when the vehicle is turning, the steering degree θstr of the steering handle 28 is large. The predetermined degree AngS2 is desirably set to a value greater than the maximum value of the steering degree θstr supposed when the vehicle performs lane change and pull over. In this way, it is appropriately determined whether the vehicle is turning.

At step S132, when the vehicle is determined to be turning, the automatic stop time period is determined to be small. In this case, at step S134, the automatic stop prohibition flag F is set to 1. Further, at step S126, the automatic stop prohibiting operation is performed.

Alternatively, when it is determined that the automatic stop prohibition flag F is set to 1 at the step S130, the processing proceeds to step S136. At step S136, it is determined whether the vehicle travels straight ahead for a predetermined time period after completing turning. The present processing is performed to determine whether the vehicle is out of a condition where it is supposed that the automatic stop time period becomes small after turning. In the present embodiment, the predetermined time period is set to smaller one of a time period after completion of turning and before a travel distance of the vehicle going straight ahead becomes greater than a predetermined distance LNG and a time period after completion of turning and before the traveling speed V of the vehicle becomes greater than a predetermined speed Vstart (0<Vstart≧V1). The predetermined time period is set in this manner, since it is determined that the vehicle has already passed through a point, such as a forward side of a crosswalk, at which the vehicle is supposed to stop temporarily, when the travel distance of the vehicle after the completion of turning becomes large or when the traveling speed V of the vehicle becomes high. The determination whether the vehicle is traveling straight ahead may be made by determining whether an absolute value of the steering degree θstr of the steering handle 28 is less than or equal to the predetermined steering degree AngS.

When step S136 makes a negative determination, a condition where the automatic stop time period is supposed to be small is determined to be continuing. In this case, at step S126, the automatic stop prohibiting operation is performed. Alternatively, at step S136, when step S136 makes a positive determination, it is determined that the vehicle is out of the condition where the automatic stop time period is supposed to be small. In this case, at step S138, the automatic stop prohibition flag F is set to 0. When the operation at step S138 is completed or when it is determined that the vehicle is not turning at the step S132, the processing proceeds to step S124. At step S124, the automatic stop operation of the engine 10 is performed.

When step S118 makes a negative determination or when the operation of steps S124 or S126 is completed, the series of processings are terminated.

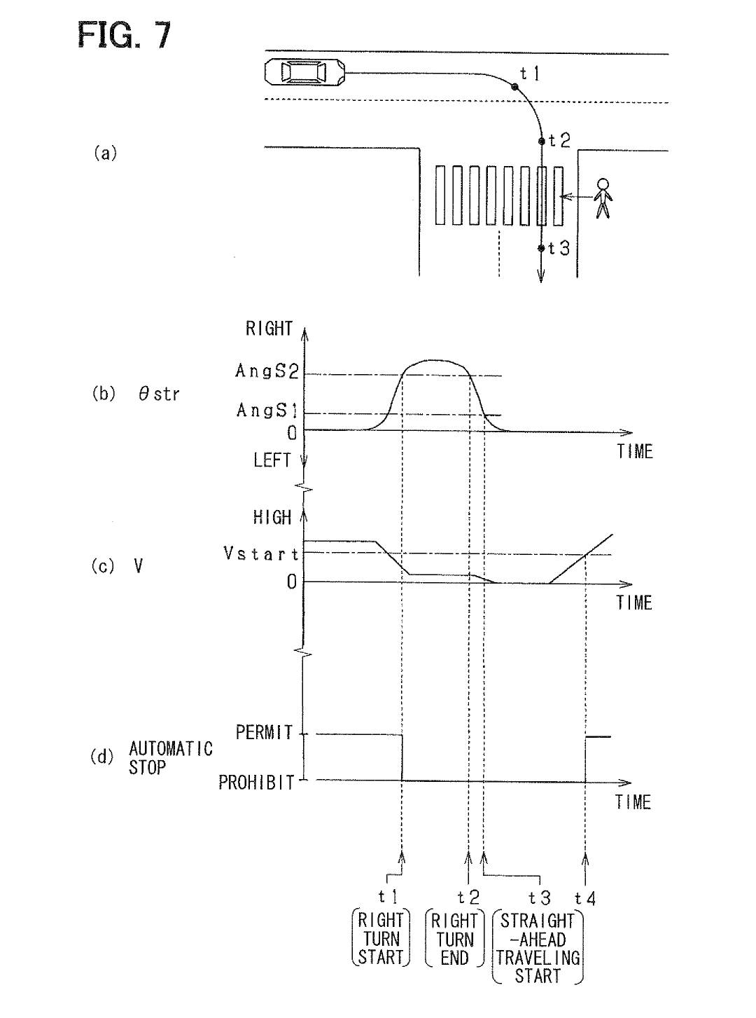

FIG. 7 shows an example of the automatic stop prohibiting operation according to the present embodiment. In FIG. 7, view (a) shows transition of a traveling state of the vehicle, a chart (b) shows transition of the steering degree θstr of the steering handle 28, a chart (c) shows transition of the traveling speed V of the vehicle, and a chart (d) shows activation of the automatic stop prohibiting operation.

In the example shown in FIG. 7, when the vehicle starts turning rightward, it is determined that an absolute value of the steering degree θstr of the steering handle 28 becomes greater than the predetermined degree AngS2 at the time t1. In this case, the automatic stop prohibiting operation is started. The automatic stop prohibiting operation is performed until the time t2 at which the right turn of the vehicle is determined to be completed. Alternatively, the automatic stop prohibiting operation is performed until the time t4 at which the traveling speed V of the vehicle becomes greater than or equal to a predetermined speed Vstart in a condition where the vehicle starts traveling straight ahead after completion of the right turn.

As described above, in the present embodiment, automatic stop of the engine 10 can be suitably restrained in a condition where the automatic stop time period is supposed to be small. Thus, reduction effect of fuel consumption can be suitably maintained.

### Third Embodiment

Hereafter, difference of the present third embodiment from the first embodiment will be described with reference to drawings.

In the present embodiment, the automatic stop prohibiting operation is performed according to the steering degree θstr of the steering handle 28 and a change rate (steering speed Vstr) of the steering degree θstr. The present operation is performed to maintain drivability of the vehicle. When the engine 10 is automatically stopped while a driver manipulates the steering handle 28 to, for example, pull over the vehicle, the driver may be incapable of driving the vehicle as desired. In this case, drivability of the vehicle may be spoiled. In general, the steering degree θstr increases when the steering handle 28 is manipulated. In consideration of this, it may be determined that a driver does not desire automatic stop of the engine 10 when, for example, an absolute value of the steering degree θstr of the steering handle 28 becomes greater than a predetermined steering degree. On such a determination, the automatic stop prohibiting operation may be performed. However, in this case, a driver may cut back the steering handle 28 to, for example, pull over the vehicle so as to return the traveling direction of the vehicle to a previous traveling direction. Consequently, the steering degree θstr of the steering handle 28 may become temporarily small, and the automatic stop operation may be permitted. Thus, the engine 10 may be undesirably stopped automatically. In general, the steering degree θstr increases when the steering handle 28 is manipulated. In consideration of this, in the present embodiment, when an absolute value of the steering degree θstr of the steering handle 28 becomes greater than a predetermined steering degree or when an absolute value of the steering speed Vstr becomes greater than a predetermined speed, it is determined to be in an operation region in which a driver does not desire automatic stop of the engine 10. In this case, the automatic stop prohibiting operation is performed.

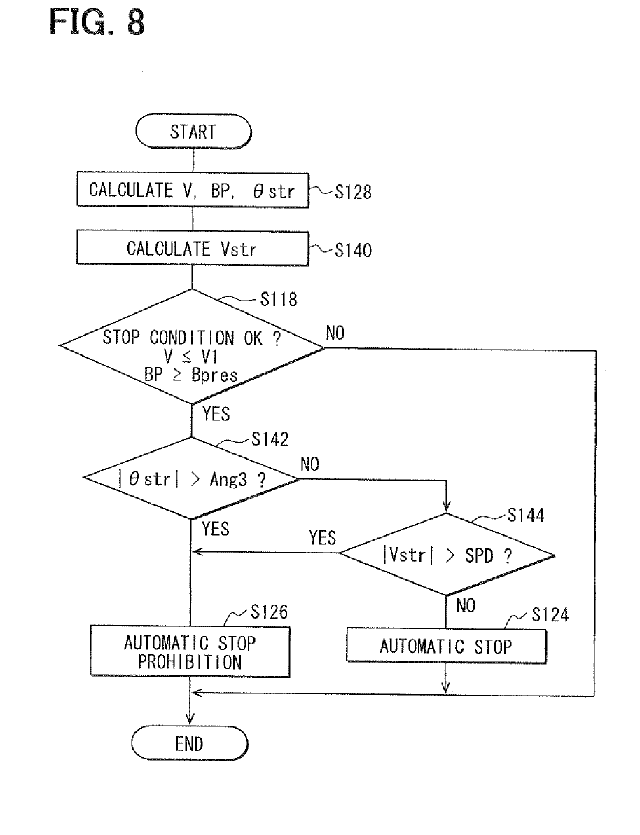

FIG. 8 shows a procedure of an idle stop control operation including the automatic stop prohibiting operation according to the present embodiment. The ECU 42 repeats the processing shown in FIG. 8 at, for example, a predetermined cycle during operation of the engine 10. In FIG. 8, the same reference numerals are denoted to equivalent steps in FIG. 4 and FIG. 6.

In the present series of processings, at step S140 subsequent to completion of operation at step S128, the steering speed Vstr is calculated. The steering speed Vstr may be calculated according to a derivative value of an output signal of the steering handle sensor 36. At subsequent step S118, it is determined whether a stop condition of the engine 10 is satisfied.

When it is determined that the stop condition of the engine 10 is satisfied at step S118, the processing proceeds to S142. At step S142, it is determined whether an absolute value of the steering degree θstr of the steering handle 28 is greater than a predetermined steering degree ANG3. When step S142 makes a negative determination, the processing proceeds to step S144. At step S144, it is determined whether an absolute value of the steering speed Vstr is greater than a predetermined speed SPD. Steps S142 and S144 are for determining whether it is in an operation region in which a driver does not desire automatic stop of the engine 10.

When steps S142 and S144 make positive determinations, it is determined that the present operation region is the automatic stop prohibition region. In this case, at step S126, the automatic stop prohibiting operation of the engine 10 is performed.

On the other hand, when step S144 makes a negative determination, the processing proceeds to step S124. At step S124, the automatic stop operation of the engine 10 is performed.

When step S118 makes a negative determination or when the operation of steps S124 or S126 is completed, the series of processings are terminated.

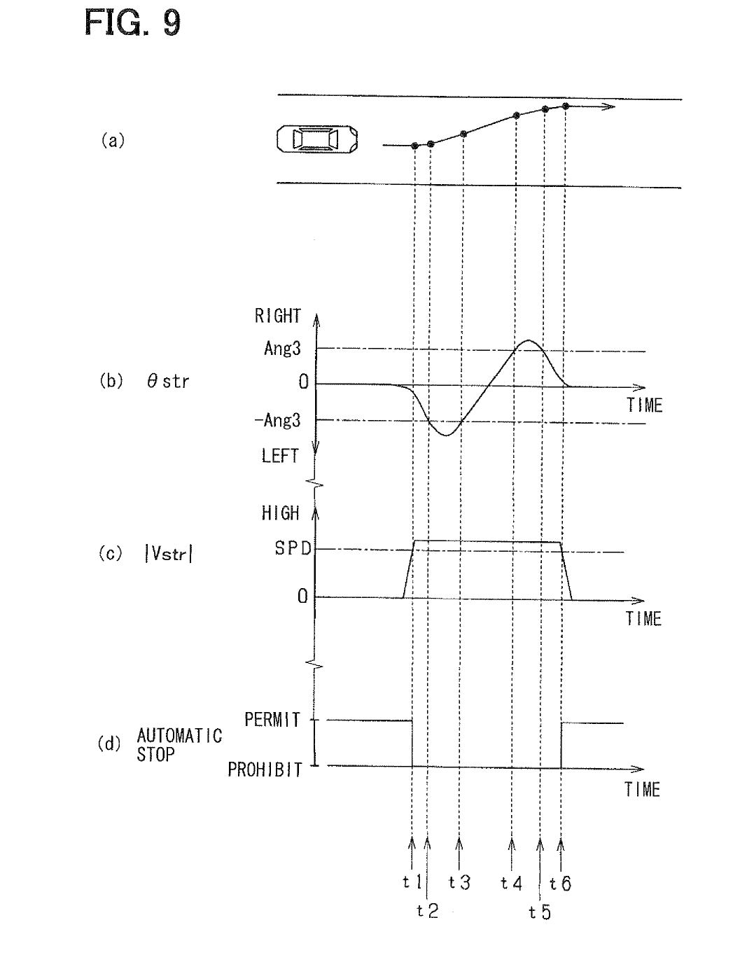

FIG. 9 shows an example of the automatic stop prohibiting operation according to the present embodiment. Specifically, in FIG. 9, a chart (c) shows a transition of an absolute value of the steering speed Vstr. A view (a) and charts (b), (d) of FIG. 9 correspond to the view (a), the charts (b), (d) of FIG. 7. In the chart (c) of FIG. 9, reduction in an absolute value of the steering speed Vstr around a time point, at which an absolute value of the steering degree θstr of the steering handle 28 become maximum, is omitted.

In the present example, the automatic stop prohibiting operation is performed in a part of the time period between the times t1 and t6 when pull over of the vehicle is performed. More specifically, the automatic stop prohibiting operation is performed in all the time period between the times t1 and t2, the time period between the times t3 and t4, and the time period between the times t5 and t6, in addition to the time period between the times t2 and t3 and the time period between the times t4 and t5. In the time period between the times t2 and t3 and the time period between the times t4 and t5, an absolute value of the steering degree θstr of the steering handle 28 becomes greater than the predetermined steering degree ANG3. In the time period between the times t1 and t2, the time period between the times t3 and t4, and the time period between the times t5 and t6, an absolute value of the steering speed Vstr becomes greater than the predetermined speed SPD.

In the present embodiment, determination whether it is in an operation region, in which a driver does not desire automatic stop of the engine 10, can be appropriately made according to both the steering degree θstr of the steering handle 28 and the steering speed Vstr in this way.

### Other Embodiments

The above embodiments may be modified in the following manner.

The method for calculating the turning radius R of the vehicle is not limited to the exemplified method in the first embodiment. For example, a vehicle may have a function to steer a rear wheel when a front wheel (steering wheel 26) is being steered, in order to reduce the minimum turning radius of the vehicle. In this case, the turning radius R of the vehicle may be calculated in consideration of the wheel angle of the rear wheel.

The method for determining whether the brake device is being operated is not limited to the exemplified method in the first embodiment. For example, determination whether the brake device is being operated may be made according to an output signal of a brake sensor for detecting depression of the brake pedal. Alternatively, this determination may be made based on an output signal of a sensor, which changes, for example, between an ON state (brake operation) and an OFF state (non brake operation) according to depression of the brake pedal.

The method for calculating the angular change Δθcar is not limited to the exemplified method in the first embodiment. For example, when the vehicle has a detection function such as a yaw rate sensor for detecting a turning angular speed of the vehicle, an output signal of the detection function may be used for the calculation.

The method for determining whether the traveling pattern of the vehicle shifts to the straight traveling pattern is not limited to the exemplified method in the first embodiment. For example, it may be determined that the traveling pattern of the vehicle has shifted on determination that an absolute value of the steering degree θstr of the steering handle 28 is less than the predetermined steering degree AngS continually for a predetermined time period. This predetermined time period may be the time period between the times t3 and t4 in FIG. 5.

The method for assigning the automatic stop prohibition region is not limited to the exemplified method in the first embodiment. For example, only a case where the traveling pattern of the vehicle shifts to the lane change pattern may be assigned as the automatic stop prohibition region. Alternatively, for example, an operation region, in which an absolute value of the vehicle direction change angle θcar is greater than the first predetermined angle AngV1 and less than or equal to the second predetermined angle AngV2, may be assigned as the automatic stop prohibition region. For example, the wheel angle θtire of the steering wheel 26 may be used as a parameter associated with the automatic stop prohibition region, instead of the steering degree θstr of the steering handle 28.

In the first embodiment, a method for quantifying the vehicle direction change angle θcar, which is an integration value of the angle between the straight-ahead direction of the vehicle and the actual traveling direction of the vehicle at each time, is exemplified. This method is not limited to use the time integration value of the angular velocity (angular change Δθcar). For example, the vehicle direction change angle θcar may be quantified by using an integration value of a value, which is associated with the steering degree θstr or the wheel angle θtire, at each time the vehicle travels for a predetermined distance. In this case, as the steering degree θstr or the wheel angle θtire increases relative to 0, the associated value may be increased as a positive value, and as the steering degree θstr or the wheel angle θtire decreases relative to 0, the associated value may be decreased as a negative value. In this way, a net value of the change angle between the traveling direction of the vehicle and the going-straight traveling from a specific time point can be quantified appropriately.

The method for determining whether the present condition has moved out of a condition, in which the automatic stop time period is supposed to be small, is not limited to the exemplified method in the second embodiment. For example, the predetermined time period in the determination may be a time period from completion of turning of the vehicle to a time point at which the going-straight travel distance of the vehicle becomes greater than or equal to the predetermined distance LNG. Alternatively, the predetermined time period in the determination may be a time period from completion of turning of the vehicle to a time point at which the traveling speed V of the vehicle becomes greater than the predetermined speed Vstart. Alternatively, for example, it may be determined that the present condition has moved out of the condition on determination that the vehicle travels straight ahead for a predetermined time after completion of turning.

The stop condition of the engine 10 related to the traveling speed V of the vehicle is not limited to the condition exemplified in the second embodiment. For example, the stop condition of the engine 10 related to the traveling speed V may be satisfied when the traveling speed V of the vehicle becomes 0.

The method for performing the automatic stop prohibiting operation in a condition where a driver does not desire automatic stop of the engine 10 is not limited to the exemplified method in the third embodiment. For example, the automatic stop prohibiting operation may be performed according to only the steering speed Vstr. Specifically, the automatic stop prohibiting operation may be performed in a time period in which it is determined that an absolute value of the steering speed Vstr becomes greater than the predetermined speed SPD. Alternatively, the automatic stop prohibiting operation may be performed in a predetermined time period from a time point at which it is determined that an absolute value of the steering speed Vstr becomes less than or equal to the predetermined speed SPD. In this way, even when the steering speed Vstr temporarily decreases due to cut back of the steering handle 28, the automatic stop prohibiting operation can be performed appropriately.

Summarizing the above embodiments, a control device for an internal combustion engine, the control device configured to be employed in a vehicle having a steering device, which is configured to be manipulated by a driver to steer a steering wheel of the vehicle, the control device configured to perform an automatic stop operation and a restart operation of an in-vehicle internal combustion engine, the control unit includes a prohibition unit configured to prohibit the automatic stop operation according to transition of a steering degree of the steering device when the vehicle travels.

Transition of the steering degree of the steering device when a driver travels the vehicle differs from transition of the steering degree when the driver intends to stop the vehicle. The present inventor found that determination whether the driver intends to stop the vehicle can be made with high accuracy according to transition of the steering degree of the steering device. Specifically, this determination can be made by comparing values of the steering degree at arbitrary time points. In consideration of the fact, the prohibition unit is configured to prohibit the automatic stop operation according to transition of the steering degree. In this way, intention of a driver to stop the vehicle can be determined with high accuracy so as to determine activation or deactivation of the automatic stop operation.

The automatic stop operation is permitted when the vehicle travels.

In this way, fuel consumption reducing effect of the internal combustion engine can be further enhanced by permitting the automatic stop operation when the vehicle travels. However, in this case, an operation region, in which the internal combustion engine is automatically stopped, is extended. Therefore, automatic stop of the internal combustion engine tends to occur while the vehicle travels, regardless of intension of the driver. Therefore, the prohibition unit effectively functions in the present control device.

The control device further includes a change angle arithmetic unit configured to calculate a vehicle direction change angle as the transition of the steering degree, the vehicle direction change angle being an integration value of an angle between a straight-ahead direction of the vehicle and an actual traveling direction of the vehicle at each time. The prohibition unit is configured to prohibit the automatic stop operation according to the calculated vehicle direction change angle.

For example, when a driver operates the vehicle to approach (pull over) a road shoulder and when the internal combustion engine is automatically stopped, the driver may be incapable of driving the vehicle desirably. Consequently, drivability of the vehicle may be spoiled. In consideration of this fact, the present inventor noted that the values of the vehicle direction change angle differ in each of the traveling patterns, such as pull over, of the vehicle caused by the driver. Therefore, determination of a traveling pattern, in which a driver does not desire automatic stop of the internal combustion engine, is made according to the vehicle direction change angle, and the automatic stop operation is prohibited in a specific traveling pattern. In this way, automatic stop of the internal combustion engine contrary to an intension of a driver can be restrained, and drivability of the vehicle can be suitably maintained.

The control device further includes a storage unit configured to store information on an operation region in which the automatic stop operation is prohibited, the operation region being associated with the vehicle direction change angle. The prohibition unit is configured to prohibit the automatic stop operation according to the vehicle direction change angle in the operation region.

The present inventor noted that the traveling pattern of the vehicle, in which a driver does not desire automatic stop of the internal combustion engine, significantly depends on the vehicle direction change angle. Therefore, the automatic stop operation in the traveling pattern of the vehicle, in which a driver does not desire automatic stop of the internal combustion engine, can be prohibited appropriately by prohibiting the automatic stop operation according to the vehicle direction change angle in the operation region.

The operation region is associated with the steering degree of the steering device and the vehicle direction change angle.

Transition of the steering degree of the steering device differs in each traveling pattern of the vehicle. In consideration of this, the traveling pattern of the vehicle, in which a driver does not desire automatic stop of the internal combustion engine, can be determined with high accuracy by associating the operation region with the steering degree and the vehicle direction change angle.

The change angle arithmetic unit is configured to calculate the vehicle direction change angle according to the steering degree of the steering device or the wheel angle of the steering wheel and the traveling speed of the vehicle.

Thus, the vehicle direction change angle is appropriately computable.

The control device further includes a reset unit configured to reset the vehicle direction change angle according to continuation of a condition where the steering degree of the steering device is less than or equal to a predetermined value for a predetermined time period.

When the traveling pattern of the vehicle shifts to the straight traveling pattern, the vehicle direction change angle is unchanged from the previous value before the shift. Accordingly, when the present vehicle direction change angle, which is presently calculated according to the previous vehicle direction change angle before the shift, is a specific value, the present traveling pattern after the shift may not be determined appropriately. Consequently, the traveling pattern, in which a driver does not desire automatic stop of the internal combustion engine, may not be determined appropriately. It is noted that the steering degree of the steering device is in general maintained small when the traveling pattern of the vehicle shifts to the straight traveling pattern. In consideration of this, it is determined that the traveling pattern of the vehicle shifts to the straight traveling pattern according to continuation of a condition where the steering degree of the steering device is less than or equal to a predetermined value for a predetermined time period. Further, the vehicle direction change angle is reset on the present determination. In this way, the present traveling pattern of the vehicle can be determined with high accuracy.

The control device further includes a unit configured to prohibit the automatic stop operation in response to that the steering degree of the steering device becomes greater than a predetermined value. The prohibition unit is configured to prohibit the automatic stop operation from a time point, at which the steering degree of the steering device as the transition of the steering degree becomes less than or equal to the predetermined value, to a time point, at which it is determined that the vehicle travels straight ahead for a predetermined time period, according to the steering degree from the time point, at which the steering degree of the steering device, becomes less than or equal to the predetermined value.

When the vehicle is stopped to wait for an oncoming vehicle while turning rightward or leftward in an intersection, quick start of the vehicle is required after temporary stop. Alternatively, supposing that the vehicle is stopped to wait for a pedestrian crossing a crosswalk after the vehicle turns, quick start of the vehicle is also required after temporary stop in a predetermined time period after the vehicle completes turning before the vehicle starts traveling straight ahead. When the internal combustion engine is automatically stopped under such a condition, a time period (automatic stop time period), in which the internal combustion engine is automatically stopped, may become small. Consequently, fuel consumption reducing effect may be spoiled. Therefore, in consideration of that the steering degree of the steering device increases during the vehicle turns, the vehicle is determined to be turning and the automatic stop operation is prohibited when the steering degree becomes greater than a predetermined value. Subsequently, the automatic stop operation is prohibited until determination that the vehicle travels straight ahead for a predetermined time period is made according to the steering degree from the time point at which the steering degree becomes less than or equal to a predetermined value. In this way, automatic stop of the internal combustion engine can be suitably restrained in a condition where the automatic stop time period is supposed to be small. Thus, reduction effect of fuel consumption can be suitably maintained.

The predetermined time period is at feast one of a time period from a time point, at which the steering degree becomes less than or equal to a predetermined value, to a time point, at which a travel distance of the vehicle becomes greater than or equal to a predetermined distance and a time period from a time point, at which the steering degree becomes less than or equal to a predetermined value, to a time point, at which a traveling speed of the vehicle becomes greater than or equal to a predetermined speed.

Thus, a time period, in which quick start of the vehicle is required after the vehicle turns, can be appropriately determined.

The control device further includes a unit configured to calculate a change rate of the steering degree according to the transition of the steering degree. The prohibition unit is configured to prohibit the automatic stop operation in response to that the calculated change rate becomes greater than or equal to a predetermined rate.

For example, when a driver operates the vehicle to approach a road shoulder and when the internal combustion engine is automatically stopped, the driver may be incapable of driving the vehicle desirably. Consequently, drivability of the vehicle may be spoiled. In general, under a condition where a driver does not desire automatic stop of the internal combustion engine, a change rate (steering speed) of the steering degree becomes large due to manipulation of the steering device. In consideration of this, according to the present invention, it is determined that a driver does not desire automatic stop in the present condition thereby to prohibit the automatic stop operation, in response to that the steering speed becomes greater than or equal to a predetermined value. In this way, occurrence of automatic stop of the internal combustion engine contrary to an intension of a driver can be restrained, and drivability of the vehicle can be suitably maintained.

The control device further includes a unit configured to prohibit the automatic stop operation in response to that the steering degree of the steering device becomes greater than a predetermined degree.

In this case, it is determined whether a driver does not desire automatic stop of the internal combustion engine in the present condition with high accuracy.

### Fourth Embodiment

As follows, a fourth embodiment of a control unit for an internal combustion engine will be described with reference to drawings.

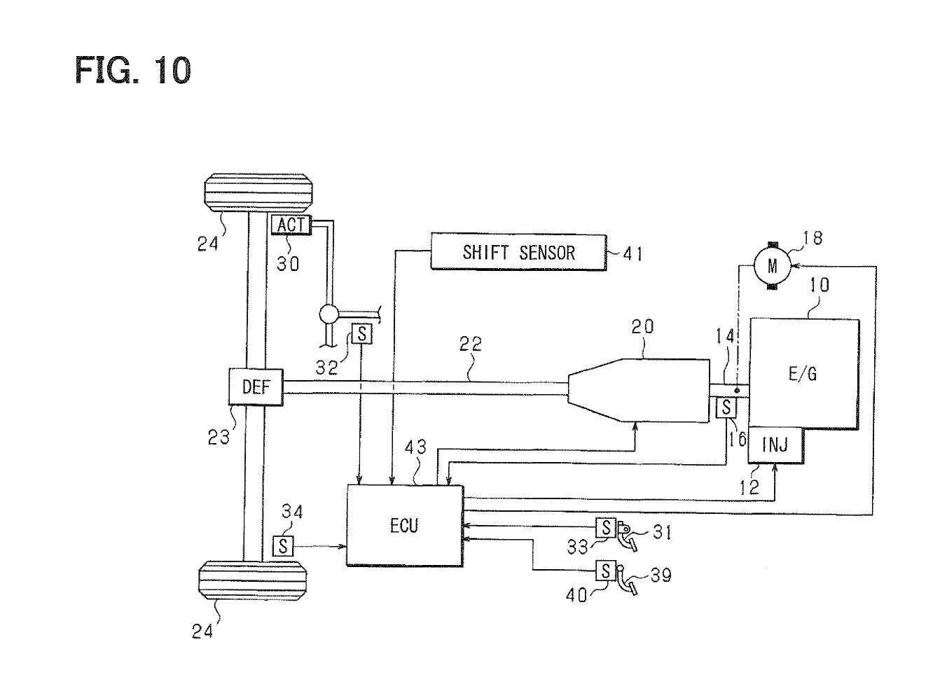

FIG. 10 shows a system configuration according to the present embodiment.

An engine 10 has cylinders each provided with a fuel injection valve 12 for injecting fuel into a combustion chamber of the engine 10. Air-fuel mixture of injected fuel and intake air is burned to generate energy, and the generated energy causes a rotational power (engine output torque) of an output shaft (crankshaft 14) of the engine 10. A crank angle sensor 16 is provided in the vicinity of the crankshaft 14 for detecting a rotation angle of the crankshaft 14.

The starter 18 is connected to the crankshaft 14. In response to activation of a starter switch, the starter 18 is activated to start cranking so as to add initial rotation to the crankshaft 14 in order to start the engine 10.

Rotation power of the crankshaft 14 is transmitted to the transmission device 20. The transmission device 20 converts a rotation speed of an input shaft (not shown), to which torque of the crankshaft 14 is transmitted, into a different rotation speed of the output shaft 22 according to a change gear ratio corresponding to a shift position.

Rotation power of the output shaft 22 is transmitted to driving wheels 24 via the deferential gear 23. The rotation speed of the output shaft 22 is converted into a different rotation speed of the driving wheel 24 according to a change gear ratio (deferential-gear ratio) of the deferential gear 23. Wheel speed sensors 34 are provided near the driving wheels 24 and steering wheels (not shown) for detecting a traveling speed of the vehicle.

The brake actuator 30 is provided near each of the wheels to apply braking force according to depression of the brake pedal 31. Specifically, as depression of the brake pedal 31 increases, a hydraulic pressure (brake hydraulic pressure) in a hydraulic pressure system of the brake device becomes large. Thereby, the braking force exerted by the brake actuator 30 to the driving wheels 24 and the like becomes large. The brake hydraulic pressure sensor 32 is provided to the hydraulic pressure system of the brake device for obtaining a brake hydraulic pressure by detecting, for example, a master cylinder pressure.

A brake sensor 33 is provided to the brake pedal 31 for detecting depression of the brake pedal 31. The accelerator sensor 40 is provided to an accelerator pedal 39 for detecting depression (accelerator manipulation) of the accelerator pedal 39. Output signals of these various sensors, a shift position sensor 41 for detecting a shift position, the crank angle sensor 16, the wheel speed sensor 34, the brake hydraulic pressure sensor 32, and the like are inputted into an electronic control unit (ECU) 43.

The ECU 43 includes a generally known microcomputer as a main unit including a CPU, a ROM, a RAM, and the like. The ECU 43 executes various kinds of control programs stored in the ROM according to the input signals from the sensors. Thereby, the ECU 43 performs a fuel injection control to operate the fuel injection valve 12, a starting control to operate the starter 18, and the like.

The ECU 43 performs an idle stop control including an automatic stop operation to stop the engine 10 automatically, when a predetermined stop condition is satisfied, and a restart operation to restart the engine 10 when a predetermined restart condition is satisfied subsequent to the automatic stop operation. In this way, a fuel consumption reduction effect of the engine 10 can be achieved. In the present embodiment, in order to enhance a fuel consumption reducing effect further by the idle stop control, activation of the automatic stop operation is permitted even when the vehicle is traveling. It is required to set the stop condition such that intention of a driver to stop the vehicle can be determined while the vehicle is traveling. A traveling speed of the vehicle and a deceleration quantity of the vehicle may be used as parameters for determining intention to stop the vehicle. In general, when a driver depresses the brake pedal 31 to stop the vehicle or control a traveling speed of the vehicle, a braking force is controlled to manipulate a deceleration quantity of the vehicle as intended by the driver according to the traveling speed in a time period from starting of depressing the brake pedal 31 until the vehicle stops or the speed control is completed. A transition of a deceleration quantity of the vehicle caused by stepping the brake pedal 31 when the driver does not have an intension to stop the vehicle is different from a transition of a deceleration quantity when the driver has an intension to stop the vehicle. Therefore, a traveling speed of the vehicle and a deceleration quantity of the vehicle can be used as a parameter for determining an intension of a driver to stop the vehicle.

A deceleration quantity of the vehicle is, in general, obtained by calculating a derivative value of an output signal of a sensor such as the wheel speed sensor 34 for detecting the traveling speed of the vehicle. It is noted that when a deceleration quantity of the vehicle calculated as the derivative value is used as the parameter, an intension of a driver to stop the vehicle may not be appropriately determined. In general, an output signal of a sensor includes a noise, and such noise may be amplified by differential computation of a sensor output. Consequently, a deceleration quantity of the vehicle may not be appropriately calculated due to amplified noise. Accordingly, when a deceleration quantity of the vehicle is used as a parameter for determining an intension of a driver to stop the vehicle, the engine 10 may be automatically stopped while the vehicle is traveling contrary to an intension of the driver. Consequently, drivability of the vehicle may be spoiled. In particular, an output signal of a sensor for detecting a traveling speed of a vehicle may contain noise caused by oscillation received from a road surface while the vehicle is traveling. In this case, amplification of noise caused by differential computation may become remarkable. In order to solve the problem, a sensor output signal may be filtered to remove noise contained in the sensor output signal. Nevertheless, a filtered sensor output signal may include a delay in response. Therefore, in this case, a deceleration quantity of the vehicle may not be appropriately calculated by using a sensor output signal containing a certain delay in response.

So as to solve such a problem, the present inventor noted a force working in the traveling direction of the vehicle as a parameter enabling determination of an intension of a driver to stop the vehicle while the vehicle is traveling. The force (vehicle braking force FC, vehicle decelerating force) working in the traveling direction of the vehicle is a resultant force, which is an addition of a force working in an acceleration direction of the vehicle and a force working in a deceleration direction of the vehicle. The force working in the deceleration direction of the vehicle includes a braking force caused by the brake device. The vehicle braking force FC has a positive value when working in the deceleration direction of the vehicle. As follows, a method for setting the stop condition and the restart conditions based on the vehicle braking force FC will be described in detail.

<1. Method for Setting Stop Condition>

In the present embodiment, the vehicle braking force FC is defined by the following formula (1).

FC=Fbk+Fv−Feg (1)

(A) Engine Driving Force Feg:

The engine driving force Feg is a torque generated by the engine and transmitted to the driving wheels 24. Specifically, the engine driving force Feg is calculated according to a value calculated by multiplying an engine output torque by a change gear ratio and a deferential-gear ratio of the transmission device 20. The engine output torque is calculated by subtracting a torque loss from a torque generated in the engine by combustion of air-fuel mixture. The torque loss includes a friction loss, which is caused by friction between sliding portions such as a piston and a cylinder of the engine 10, and a pumping loss. The engine driving force Feg increases as a driver further depresses the accelerator device to increase a request torque to the engine 10. The change gear ratio may be calculated according to an output signal of the shift position sensor 41. The engine output torque may be calculated from an accelerator manipulation based on an output signal of the accelerator sensor 40 and an engine speed based on an output signal of the crank angle sensor 16.

(B) Braking Force Fbk of Brake Device:

The braking force Fbk of the brake device may be calculated from a brake hydraulic pressure based on an output signal of the brake hydraulic pressure sensor 32.

(C) Travel Resistance Fv on Vehicle:

A travel resistance Fv working on the vehicle is a summation of an air resistance working on the vehicle, a rolling resistance of wheels, and a slope resistance (hill climbing resistance). A rolling resistance of wheels increases as the weight of the vehicle increases. An air resistance increases as a traveling speed of the vehicle increases. A slope resistance increases as a slope of a road surface on which the vehicle travels becomes steep in a climbing form. In the present embodiment, a rolling resistance of wheels is calculated from a predetermined rolling resistance coefficient and the weight of the vehicle. The predetermined rolling resistance coefficient is determined with respect to a condition of a road surface on which the vehicle is supposed to travel frequently. An air resistance is calculated from a traveling speed of the vehicle calculated from an output signal of the wheel speed sensor 34. The slope resistance is calculated according to a slope (road surface slope) of a road surface and the weight of the vehicle. A road surface slope may be estimated from, for example, a difference between a change rate (actual acceleration and deceleration quantity) in a traveling speed of the vehicle supposed from a present engine driving force Feg and a present braking force Fbk of the brake device under an assumption that the vehicle travels on a flat road, on which a road surface slope is 0, and an actual acceleration and deceleration quantity. A traveling speed of the vehicle when the idle stop control is performed is in a low-speed range. Effect of an air resistance is small relative to the vehicle braking force FC when the vehicle is in a low-speed range. In consideration this, an air resistance may be ignored in calculation of the supposed acceleration and deceleration quantity. The actual acceleration and deceleration quantity may be obtained by filtering a derivative value of an output signal of the wheel speed sensor 34. The present calculation of the actual acceleration and deceleration quantity is based on assumption that a response delay of the filtered sensor output signal has a small influence to an accuracy of the estimation of the road surface slope, since a road surface slope is supposed to change gradually when the vehicle travels.

The vehicle braking force FC calculated in this way has a small influence caused by noise of a sensor output signal, compared with a vehicle braking force calculated by multiplying a deceleration quantity of the vehicle, which is calculated as a derivative value of the sensor output signal, by the weight of the vehicle. Thus, the vehicle braking force FC may be used as a parameter for determining an intension of a driver to stop the vehicle with high accuracy.

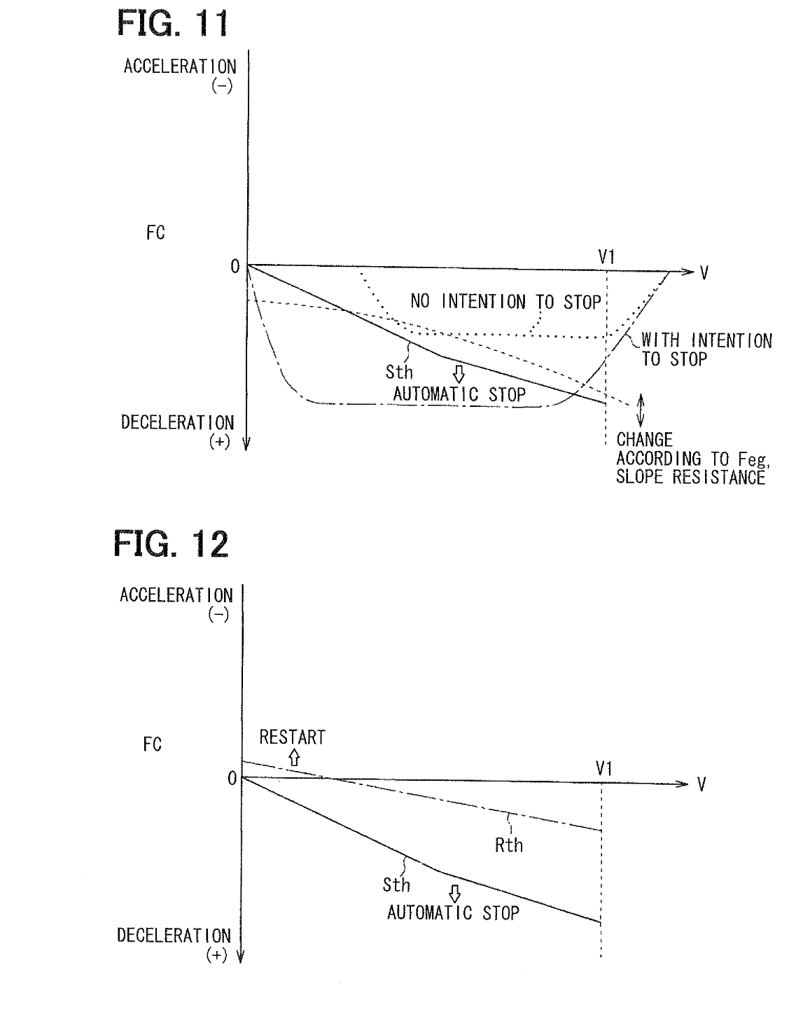

FIG. 11 is a graph showing one example of the vehicle braking force FC. The dashed line in FIG. 11 shows a vehicle braking force FC when the braking force Fbk of the brake device is constant. As a traveling speed V of the vehicle increases, an air resistance increases. Therefore, as a traveling speed V of the vehicle increases, a vehicle braking force FC also increases. In addition to change in an air resistance, the vehicle braking force FC changes in dependence upon change in a slope resistance caused by change in a traveling state of the vehicle and change in an engine driving force Feg caused by change in an operation state of the engine 10. A driver manipulates the braking force Fbk of the brake device to control a deceleration quantity of the vehicle as desired, while a traveling state of the vehicle and an operation state of the engine 10 change.

In the present embodiment, as described above, a deceleration quantity of the vehicle has a different tendency in dependence upon whether a driver has an intention to stop the vehicle or not. In consideration of this, a first threshold Sth (>0) shown by the solid line in FIG. 11 is set. The first threshold Sth is used for distinguishing a transition of the vehicle braking force FC shown by the dashed dotted line in FIG. 11 when a driver has an intension to stop the vehicle from a transition of the vehicle braking force FC shown by the dotted line in FIG. 11 when a driver does not have an intension to stop the vehicle. The first threshold Sth is a variable determined according to the traveling speed V of the vehicle. The first threshold Sth may be set by measuring transitions of the vehicle braking force FC in different cases where a driver has an intension to stop the vehicle and where a driver does not have an intension to stop the vehicle. A stop condition of the engine 10 is set to be satisfied when the vehicle braking force FC becomes greater than the first threshold Sth. In this way, it is enabled to predict whether the vehicle stops, according to the vehicle braking force FC calculated at each time and the first threshold Sth being a variable set according to the traveling speed V at each time. In addition, the automatic stop operation is performed according to a prediction that the vehicle stops. As shown by the dashed dotted line in FIG. 11, the vehicle braking force FC in case there a driver has an intension to stop the vehicle is substantially constant in a specific traveling speed region irrespective of the traveling speed V of the vehicle. The substantially constant region of the vehicle braking force FC is caused for the following reason. Specifically, a driver performs brake operation to put a high priority on restricting the braking force Fbk of the brake device not to excessively increase an inertial force working on the driver when the vehicle slows down rather than increasing the braking force Fbk to stop the vehicle quickly. Furthermore, in the present embodiment, when the traveling speed V of the vehicle exceeds the predetermined speed V1 (>0), the automatic stop operation and the restart operation of the engine 10 are prohibited.

<2. Method for Setting Restart Condition>

In the present embodiment, as shown by the dashed dotted line in FIG. 12, a second threshold Rth (Rth<Sth) is set to be less than the first threshold Sth. A restart condition of the engine 10 is set to be satisfied when the vehicle braking force FC is less than or equal to the second threshold Rth. The restart condition is set in this way so as to avoid decrease in fuel consumption reducing effect and drivability of the vehicle. In general, when a driver has an intention (acceleration intention) to accelerate the vehicle, the driver depresses the accelerator pedal 39 and releases depression of the brake pedal 31 thereby to reduce the vehicle braking force FC. In this condition, when the vehicle braking force FC becomes less than the second threshold Rth, the engine 10 is restarted by the restart operation. In a time period from when a driver starts depression of the brake pedal 31 to when the vehicle stops, the driver depresses the accelerator pedal 39 and the brake pedal 31 to control a deceleration quantity of the vehicle subtly. As a result, the vehicle braking force FC may be changed. In this case, supposing that the second threshold Rth is set to the same value as the first threshold Sth, automatic stop and restart of the engine 10 are frequently repeated. Consequently, fuel consumption reducing effect and drivability may be spoiled. Therefore, the restart condition is set in the above-described manner to define a hysteresis between the threshold for performing the automatic stop operation and the threshold for performing the restart operation. Thereby, fuel consumption reducing effect and drivability can be maintained.

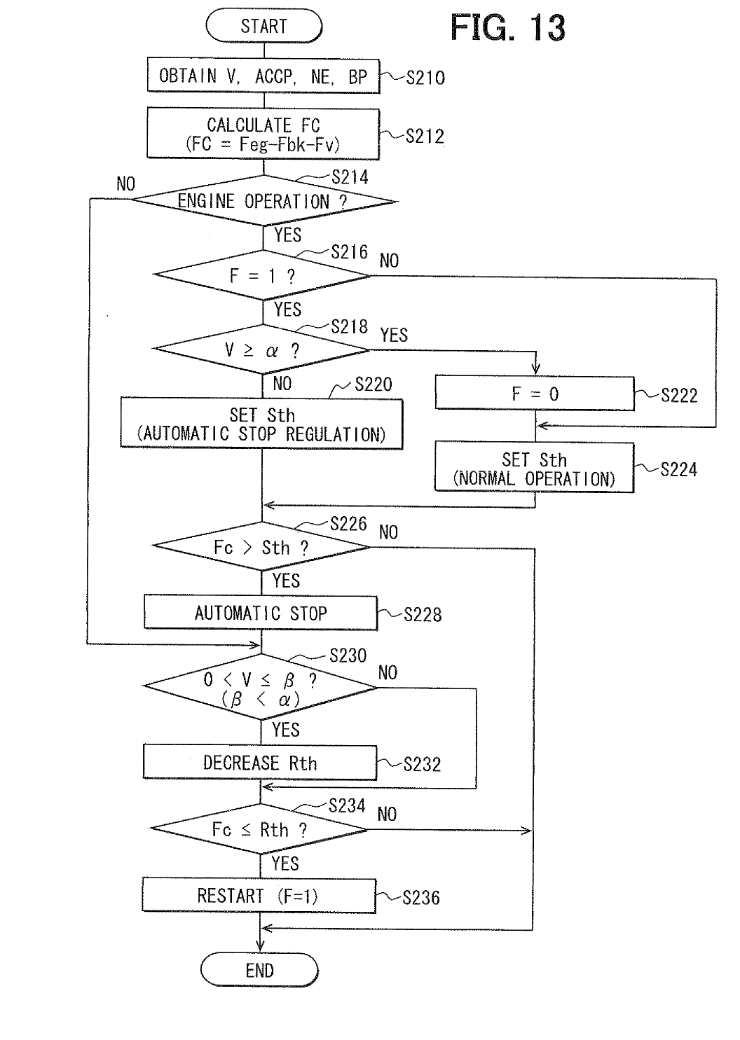

FIG. 13 shows the idle stop control operation according to the present embodiment. The ECU 43 repeats the processing shown in FIG. 13 at a predetermined cycle, for example.

In the present series of processings, at step S210, a traveling speed V, an accelerator manipulation ACCP, an engine speed NE, and a brake hydraulic pressure BP of the vehicle are first obtained.

At subsequent step S112, the vehicle braking force FC is calculated according to the obtained parameters. The vehicle braking force FC may be calculated by using the formula (1). The engine driving force Feg when the engine 10 is automatically stopped may be obtained by calculating the engine driving force Feg supposed in an idling operation of the vehicle on condition that, for example, the accelerator manipulation ACCP becomes greater than a predetermined value.

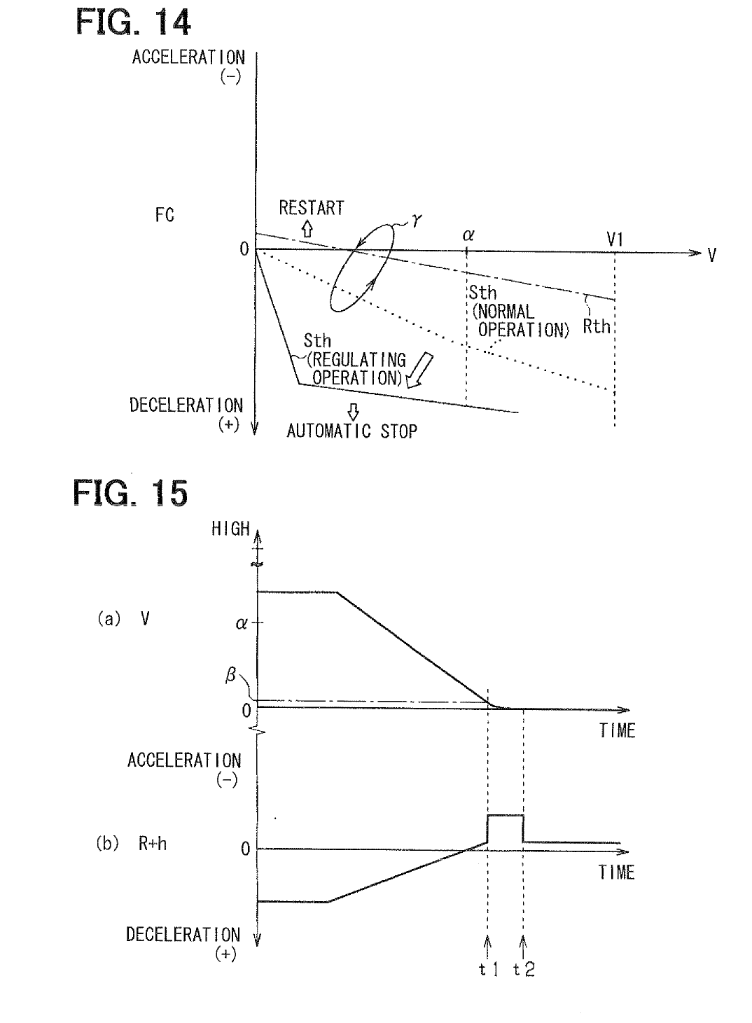

At subsequent step S214, it is determined whether the engine 10 is in operation. When it is determined that the engine 10 is in operation, the processing proceeds to S216. At step S216, it is determined whether a restart flag F is set to 1. The restart flag F is set to 1 for a predetermined time period after restart of the engine 10. At subsequent step S218, it is determined whether the traveling speed V of the vehicle is greater than or equal to a first regulation speed α (0<α<V1). The processings of steps S216 and S218 are for determining existence of activation of an automatic stop regulating operation. The automatic stop regulating operation will be described with reference to FIG. 14. The automatic stop regulating operation is performed to increase the first threshold Sth in a time period from when the engine 10 is restarted to when a traveling speed V of the vehicle becomes greater than or equal to the first regulation speed α, so as to maintain drivability of the vehicle. Specifically, when a driver intends to travel the vehicle at a low speed, the driver may alternately depress the accelerator pedal 39 and the brake pedal 31 thereby to repeat acceleration and deceleration of the vehicle. In this case, as shown by the oval area γ in FIG. 14, automatic stop and restart of the engine 10 may be repeated due to change in the vehicle braking force FC. Consequently, drivability of the vehicle may be spoiled. It is conceivable to set the second threshold Rth to be sufficiently small relative to the first threshold Sth. However, in this case, even when a driver depresses the accelerator pedal 39 to accelerate the vehicle, it takes long before the vehicle braking force FC reaches the second threshold Rth. Consequently, it takes long before the restart condition is satisfied. Thus, the engine 10 cannot be quickly restarted in response to an intention of a driver to accelerate the vehicle. In this case, drivability of the vehicle may be spoiled. In consideration of this, as shown by the solid line in FIG. 14, the first threshold Sth for the automatic stop regulating operation is set to be greater than a value for a normal idle stop control shown by the dotted line, in a time period from restart of the engine 10 to when the traveling speed V of the vehicle becomes greater than or equal to the first regulation speed α. Thereby, low-speed traveling of the vehicle and the quick restart of the engine 10 can be enabled in response to an intension of a driver to accelerate the vehicle. Thus, drivability of the vehicle can be maintained.

Referring to FIG. 13, when the restart flag F is determined to be 1 at step S216 and when the traveling speed V of the vehicle is determined to be less than the first regulation speed α at step S218, it is determined that a driver continually intends to travel the vehicle at a low speed. In this case, at step S220, the first threshold Sth is set to the value for the automatic stop regulating operation correspondingly to the traveling speed V of the vehicle. The first threshold Sth is set to be a large value as the traveling speed V of the vehicle becomes high.

Alternatively, when step S218 makes a positive determination, it is determined that the vehicle is out of the condition where the vehicle travels at a low speed. In this case, at step S222, the restart flag F is set to 0.

When step S216 makes a negative determination or when the operation of step S222 is completed, the processing proceeds to step S224. At step S224, the first threshold Sth is set to a value for a normal idle stop control according to the traveling speed V of the vehicle. The first threshold Sth for the automatic stop regulating operation and the first threshold Sth for the normal idle stop control are variably set using a data map or an equation, in which the first threshold Sth is associated with the traveling speed V of the vehicle, according to the traveling speed V of the vehicle. The data map or the equation is stored beforehand in a storage unit of the ECU 43. The storage unit is, for example, a nonvolatile memory such as an EEPROM.

After completion of the operations of steps S220 and S224, the processing proceeds to step S226. At S226, it is determined whether the stop condition of the engine 10 is satisfied. The present operation at S226 is performed for predicting whether the vehicle stops or not. As described above, the stop condition is set to be satisfied when the vehicle braking force FC becomes greater than the first threshold Sth.

At step S226, when it is determined that the stop condition of the engine 10 is satisfied, at step S228, the automatic stop operation of the engine 10 is performed. The automatic stop operation is performed to stop the engine 10 by terminating fuel injection from the fuel injection valve 12.

When the operation at step S228 is completed or when it is determined that the engine 10 is stopped at the step S214, the processing proceeds to step S230. At steps S230, S232, a restart regulating operation is performed. The restart regulating operation will be described with reference to FIG. 15. In FIG. 15, a chart (a) shows a transition of the traveling speed V of the vehicle, and a chart (b) shows a transition of the second threshold Rth. The restart regulating operation is performed to set the second threshold Rth to a small value for a predetermined time period between the time t1 and the time t2 when it is determined that the vehicle is starting to stop (immediately before stopping), so as to maintain drivability of the vehicle. Specifically, a driver may reduce depression of the brake pedal 31 to reduce the braking force Fbk of the brake immediately before stopping the vehicle so as to mitigate shock caused by depression of the brake pedal 31 to stop the vehicle. Even in this case, the vehicle braking force FC decreases. Consequently, the restart condition may be satisfied contrary to an intension of a driver to stop the vehicle, due to decrease in the vehicle braking force FC. In this case, the engine 10 may be restarted, and drivability of the vehicle may be spoiled. In consideration of this, the restart regulating operation is performed to set the restart condition to be hardly satisfied for a predetermined time period from when the vehicle starts stopping. Thereby, restart of the engine 10 contrary to an intension of a driver can be avoided, and drivability of the vehicle can be maintained.

Referring to FIG. 13, at step S230, it is determined whether the traveling speed V of the vehicle is greater than 0 and less than or equal to a second regulation speed β (0<β<α). The present operation at S230 is performed for determining whether the vehicle starts stopping.

When it is determined that the vehicle starts stopping at step S230, the processing proceeds to step S232. At S232, the second threshold Rth is set to be a small value for a predetermined time period after step S230 makes a positive determination.

When the operation of step S232 is completed or when step S230 makes a negative determination, the processing proceeds to step S234. At step S234, it is determined whether the restart condition of the engine 10 is satisfied. As described above, the restart condition is set to be satisfied when the vehicle braking force FC becomes less than or equal to the second threshold Rth.

At step S234, when it is determined that the restart condition of the engine 10 is satisfied, the processing proceeds to step S236. At step S236, the restart operation of the engine 10 is performed. The restart operation is performed to activate the starter 18 to perform clanking of the engine 10 and manipulate the fuel injection valve 12 to restart the engine 10, which is being automatically stopped. After confirmation of restart of the engine 10, the restart flag F is set to 1.

When step S226 or step S234 makes a negative determination or when the operation of step S236 is completed, the series of processings are terminated.

According to the present embodiment as described above, the following effects can be produced.

(1) The vehicle braking force FC is calculated according to the engine driving force Feg, the rolling resistance of wheels, the air resistance working on the vehicle, the slope resistance, and the braking force Fbk of the brake device. The vehicle braking force FC calculated in this way has a small influence caused by noise of a sensor output signal, compared with a vehicle braking force calculated by multiplying a deceleration quantity of the vehicle, which is calculated as a derivative value of the sensor output signal, by the weight of the vehicle. Accordingly, erroneous determination of an intension of a driver to stop the vehicle due to noise can be effectively avoided. In addition, determination of an intension of a driver to stop the vehicle can be appropriately made according to the vehicle braking force FC, even when a traveling state of the vehicle and an operation state of the engine 10 are volatile.

(2) The stop condition of the engine 10 is set to be satisfied when the vehicle braking force FC becomes greater than the first threshold Sth, which is variably set according to the traveling speed V of the vehicle. In this way, the engine 10 can be automatically stopped while traveling the vehicle by reflecting an intension of a driver to stop the vehicle. Thereby, drivability of the vehicle can be suitably maintained.

(3) The restart conditions of the engine 10 is set to be satisfied when the vehicle braking force FC is less than or equal to the second threshold Rth, which is less than the first threshold Sth. In this way, repeat of automatic stop and restart of the engine 10 can be avoided. Thereby, fuel consumption reducing effect and drivability of the vehicle can be suitably maintained.

(4) The automatic stop regulating operation is performed to increase the first threshold Sth after restart of the engine 10 until the traveling speed V of the vehicle becomes greater than or equal to the first regulation speed α. In this way, low-speed traveling of the vehicle and quick restart of the engine 10 reflecting an intention of the driver to accelerate the vehicle can be enabled. Furthermore, reduction in drivability of the vehicle can be suitably avoidable.

(5) The restart regulating operation is performed to decrease the second threshold Rth, when the vehicle is determined to start stopping, i.e., when it is determined to be immediately before the vehicle starts stopping, during the engine 10 is automatically stopped, for a predetermined time period after the determination that the vehicle starts stopping. In this way, restart of the engine 10 contrary to an intension of a driver can be restrained to maintain drivability of the vehicle suitably.

(Modification)

In this regard, the present embodiment may be modified in the following manner.

The method for estimating the road surface slope is not limited to the method exemplified in the present embodiment. The road surface slope may be estimated in the following manner. Specifically, for example, a detection unit such as a car height sensor may be employed to detect a load, which is perpendicular to a road surface and applied to a suspension mechanically connected to each of the wheels, and obtain information having a correlation with the load. In this case, a component of the weight of the vehicle perpendicular to a road surface may be calculated according to a detection signal of the detection unit. Further, an absolute value of the road surface slope may be estimated by calculating the vertical component of the weight of the vehicle to a road surface based on the detection signal, dividing the weight of the vehicle by the calculated load to obtain a divisional value, and calculating an arccosine value of the divisional value. Further, under assumption that the vehicle travels on a flat way, the positive and negative sign of the absolute value is determined according to a difference between an estimated acceleration and deceleration quantity of the vehicle and an actual acceleration and deceleration quantity. The estimated acceleration and deceleration quantity of the vehicle is estimated from the present engine driving force Feg and the braking force Fbk of the brake device. The actual acceleration and deceleration quantity is obtained by filtering a derivative value of an output signal of the wheel speed sensor 34. In this way, the road surface slope may be estimated. The present estimation is made based on that fact that the vertical component of the weight of the vehicle to a road surface decreases relative to the weight of the vehicle, as the road surface slope increases. In this way, it is enabled to effectively reduce influence, which is caused by an inertial force working on the vehicle when the vehicle is accelerated or decelerated and exerted on calculation of the road surface slope. For example, an acceleration sensor may be employed for detecting both an acceleration quantity of the vehicle in a traveling direction of the vehicle and an acceleration quantity of the vehicle in a direction perpendicular to a road surface. In this case, a road surface slope may be estimated by dividing the detected acceleration quantity of the vehicle in the traveling direction by the detected acceleration quantity of the vehicle perpendicular to a road surface to obtain a divisional value, and calculating an arccosine value of the divisional value.

The stop condition of the engine 10 is not limited to that exemplified in the present embodiment. For example, the above-exemplified condition may further include a condition satisfied when an electricity accumulated in an in-vehicle battery device, which is for supplying electricity to in-vehicle devices, is greater than a predetermined amount.

The calculation method for the vehicle braking force FC is not limited to that exemplified in the present embodiment. For example, an air resistance may be removed from calculation of the vehicle braking force FC. When the idle stop control is performed, the vehicle is, in general, in a low-speed traveling speed region. Therefore, an air resistance is small relative to the vehicle braking force FC when the idle stop control is performed. Accordingly, an air resistance may be omitted from calculation of the vehicle braking force FC. For example, at least one of a rolling resistance of wheels, a slope resistance, and an engine driving force Feg may be omitted from calculation of the vehicle braking force FC. For example, force and resistance, which are small relative to the vehicle braking force FC, may be selectively omitted from calculation of the vehicle braking force FC according to a traveling state of the vehicle and a road surface slope.

The method for setting the second threshold Rth is not limited to that exemplified in the present embodiment. For example, the second threshold Rth may be set to be the same as the first threshold Sth.

In the present embodiment, the second threshold Rth is set to a negative value in the direction to accelerate the vehicle only in the low-speed area of the traveling speed V of the vehicle. The method for setting the second threshold Rth is not limited to that in the present embodiment. For example, the second threshold Rth may be set to a positive value less than the first threshold Sth in a traveling speed region (0≦V≦V1) where the idle stop control is performed. In this case, the second threshold Rth may be set such that the restart operation is performed in response to release of depression of the brake pedal 31. Further in the case, the second threshold Rth, which is decreased by the restart regulating operation, may be maintained at a positive value.

The automatic stop regulating operation is not limited to that exemplified in the present embodiment. For example, the automatic stop regulating operation may prohibit the automatic stop operation until the traveling speed V of the vehicle becomes the first regulation speed α.

The restart regulating operation is not limited to that exemplified in the present embodiment. For example, the restart regulating operation may prohibit the restart operation for a predetermined period after determination that the vehicle is starting to stop (immediately before stopping).

Summarizing the present embodiment, a control device for an internal combustion engine, the control device including a control unit configured to perform an operation to stop the internal combustion engine automatically while the vehicle travels, the control device includes:

a vehicle braking force arithmetic unit configured to calculate a vehicle braking force, which is a resultant force of an acceleration force and a deceleration force, the acceleration force working in an acceleration direction to accelerate the vehicle, the deceleration force working in a deceleration direction to decelerate the vehicle, the deceleration force including a braking force of a brake device of the vehicle, the vehicle braking force has a positive value when being in the deceleration direction to decelerate the vehicle; and

a prediction unit configured to predict whether the vehicle stops according to the calculated vehicle braking force and a traveling speed of the vehicle.

The control unit performs the operation to stop the internal combustion engine automatically according to a prediction that the vehicle stops.

In general, when a driver manipulates the brake device to stop the vehicle or control a traveling speed of the vehicle, the driver control a braking force to manipulate a deceleration quantity of the vehicle, as intended by the driver. In this case, the driver manipulates the brake device according to a traveling speed in a period from starting of manipulating the brake device until the vehicle stops or the speed control is completed. The driver controls the braking force of the brake device to produce a deceleration quantity intended by the driver, thereby to control the vehicle braking force. Therefore, there is a difference between a transition of the vehicle braking force from when the driver starts braking to when the vehicle stops, in a case where the driver has an intension to stop the vehicle, and a transition of the vehicle braking force from when the driver starts braking to when the vehicle stops, in a case where the driver does not have an intension to stop the vehicle. For example, a driver manipulates the brake device in order to control the traveling speed of the vehicle even when the driver does not have an intension to stop the vehicle. In consideration of this, it is predicted whether the vehicle stops according to the traveling speed of the vehicle and the vehicle braking force while the vehicle travels. In addition, the operation to stop the internal combustion engine automatically is performed according to a prediction that the vehicle stops. In this way, the internal combustion engine can be automatically stopped by reflecting an intension of a driver to stop the vehicle, and drivability of the vehicle can be suitably maintained.

The vehicle braking force arithmetic unit is configured to calculate the vehicle braking force according to at least one of the braking force of the brake device, a travel resistance working on the vehicle, and an output torque of the internal combustion engine. The travel resistance includes a slope resistance working on the vehicle.

When a traveling state of the vehicle and an operation state of the internal combustion engine change, the output torque of the internal combustion engine and the travel resistance may change. Even in such a condition, the vehicle braking force is calculated according to the parameters in this way. Therefore, decrease in prediction accuracy of the prediction unit can be restrained. Thus, an intension of a driver to stop the vehicle can be determined with high accuracy.

The control device further includes:

a first setting unit configured to variably set a first threshold about the vehicle braking force according to the traveling speed of the vehicle; and

a second setting unit configured to set a second threshold about the vehicle braking force, the second threshold being a value less than the first threshold.

The prediction unit is configured to predict that the vehicle stops, in response to that the vehicle braking force becomes greater than the first threshold. The control unit is configured to perform an operation to restart the internal combustion engine, in response to that the vehicle braking force becomes less than or equal to the second threshold, under a condition where the internal combustion engine is automatically stopped.

In this way, it is predicted that the vehicle stops in response to that the vehicle braking force becomes greater than the first threshold. In this case, the operation to stop the internal combustion engine automatically is performed. When a driver manipulates the braking device to control a deceleration quantity of the vehicle, the vehicle braking force may change. In this case, supposing that the threshold for restarting the internal combustion engine is set to the same value as the first threshold, automatic stop and restart of the internal combustion engine are frequently repeated. Consequently, fuel consumption reducing effect and drivability may be spoiled. Contrary, as described above, the first threshold and second threshold for performing automatic stop and restart of the internal combustion engine are set to different values from each other. Therefore, even when fluctuation of the vehicle braking force occurs due to control of a vehicle deceleration quantity, frequent repeat of automatic stop and restart of the internal combustion engine can be restrained. In this way, decrease in fuel consumption reducing effect and drivability can be suitably restrained.

The control device further includes a restart regulating unit configured to impose a regulation on activation of the operation to restart the internal combustion engine for a predetermined period, according to determination that it is immediately before stop of the vehicle, under a condition where the internal combustion engine is automatically stopped.

Immediately before the vehicle stops, a driver may manipulate the braking device to cause small braking force in order to mitigate shock caused by stop of the vehicle due to the manipulation of the braking device. Even in this case, the vehicle braking force decreases. Consequently, the internal combustion engine may be restarted contrary to an intension of a driver to stop the vehicle, due to decrease in the vehicle braking force. Consequently, drivability of the vehicle may be spoiled. On the contrary, according to the present embodiment, a regulation is imposed on activation of the operation to restart the internal combustion engine for a predetermined period, according to determination that it is immediately before stop of the vehicle. In this way, restart of the internal combustion engine contrary to an intension of a driver can be restrained, and drivability of the vehicle can be suitably maintained.

The restart regulating unit is configured to decrease the second threshold for a predetermined period so as to impose the regulation on activation of the operation to restart the internal combustion engine.

According to the present embodiment, the regulation can be suitably imposed on activation of the operation to restart the internal combustion engine.

The control device further includes an automatic stop regulation unit configured to impose a regulation on activation of the operation to stop the internal combustion engine automatically, after restart of the internal combustion engine until the traveling speed of the vehicle becomes greater than or equal to a predetermined speed.

Specifically, when a driver intends to travel the vehicle at a low speed, the driver may alternately manipulate the accelerator device and the braking device thereby to repeat acceleration and deceleration of the vehicle. In this case, the vehicle braking force fluctuates. Consequently, the internal combustion engine may be stopped automatically, contrary to an intention of a driver to travel the vehicle at a low-speed. In consideration of this, according to the present embodiment, a regulation is imposed on activation of the operation to stop the internal combustion engine automatically, after restart of the internal combustion engine until the traveling speed of the vehicle becomes greater than or equal to a predetermined speed. In this way, automatic stop of the internal combustion engine contrary to an intention of a driver to travel the vehicle at a low-speed can be avoided. Thus, drivability of the vehicle can be suitably maintained.

The automatic stop regulation unit is configured to increase the first threshold until the traveling speed of the vehicle becomes greater than or equal to a predetermined value so as to impose the regulation on activation of the operation to stop the internal combustion engine automatically.

According to the present embodiment, the regulation can be suitably imposed on activation of the operation to stop the internal combustion engine.

### Fifth Embodiment

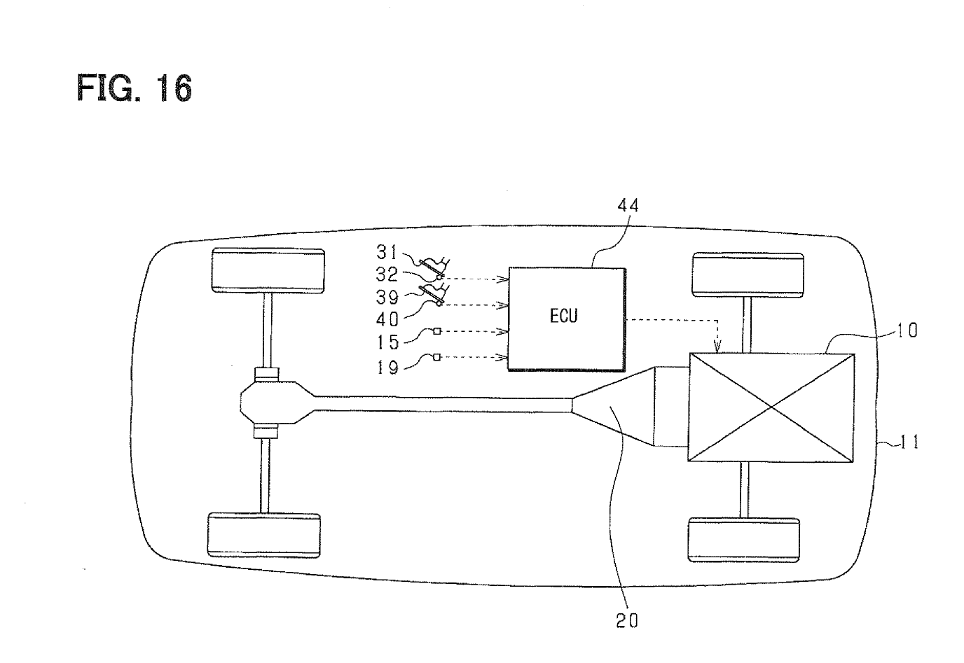

As follows, an embodiment of an idle stop control device according to the present embodiment will be described with reference to drawings. FIG. 16 is a schematic view showing an idle-stop vehicle 11 provided with an idle stop control device according to the present embodiment. The idle-stop vehicle 11 includes an internal combustion engine 10 as a driving source for traveling. An automatic transmission device 20 is mounted to an output shaft of the engine 10. The automatic transmission device 20 is for switching a gear ratio to change gears automatically according to manipulation of the accelerator pedal 39 by a driver of the vehicle, a vehicle speed, and the like.

An electronic control unit (ECU) 44 equipped in the vehicle 11 inputs detection signals of the accelerator sensor 40 and the vehicle speed sensor 15. The ECU 44 calculates depression of the accelerator pedal 39 and the vehicle speed according to these detection signals. A brake sensor 33 detects an operation stroke quantity of the brake pedal 31. The ECU 44 further inputs a detection signal of the brake sensor 33 and calculates depression (brake depression quantity) of the brake pedal 31 according to the detection signal.

The ECU (idle stop control device) 44 electronically controls a fuel injection valve (not shown) equipped in the engine 10. As described later, when, for example, permission of automatic stop is made, an automatic stop condition is satisfied. When the automatic stop condition is satisfied, the ECU 44 causes the fuel injection valve to stop fuel injection so as to stop the engine 10 automatically, thereby to perform an idle stop control.

Alternatively, when a predetermined automatic start condition is satisfied, the ECU 44 activates a starter motor (not shown) thereby to control automatic start of the engine 10. Specifically, for example, the automatic start condition is satisfied when the brake pedal 31 is not manipulated and the brake depression quantity is zero, a shift lever (not shown) for manipulating the automatic transmission device 20 is manipulated at a drive position to permit traveling of the vehicle, and the accelerator pedal 39 is manipulated.

When the present state shifts from a vehicle traveling state, in which a traveling speed of the vehicle is greater than a predetermined vehicle speed, such as 20 km/h, to a low-speed traveling state, in which the traveling speed is less than or equal to the predetermined vehicle speed, the ECU 44 performs a learning operation as described below. Specifically, the ECU 44 performs the learning operation to learn an association between the brake depression quantity and the vehicle speed, when the brake pedal 31 is first depressed after the present state shifts to the low-speed traveling state, and whether the vehicle result in stop by the depression of the brake device to decrease the vehicle speed to 0.

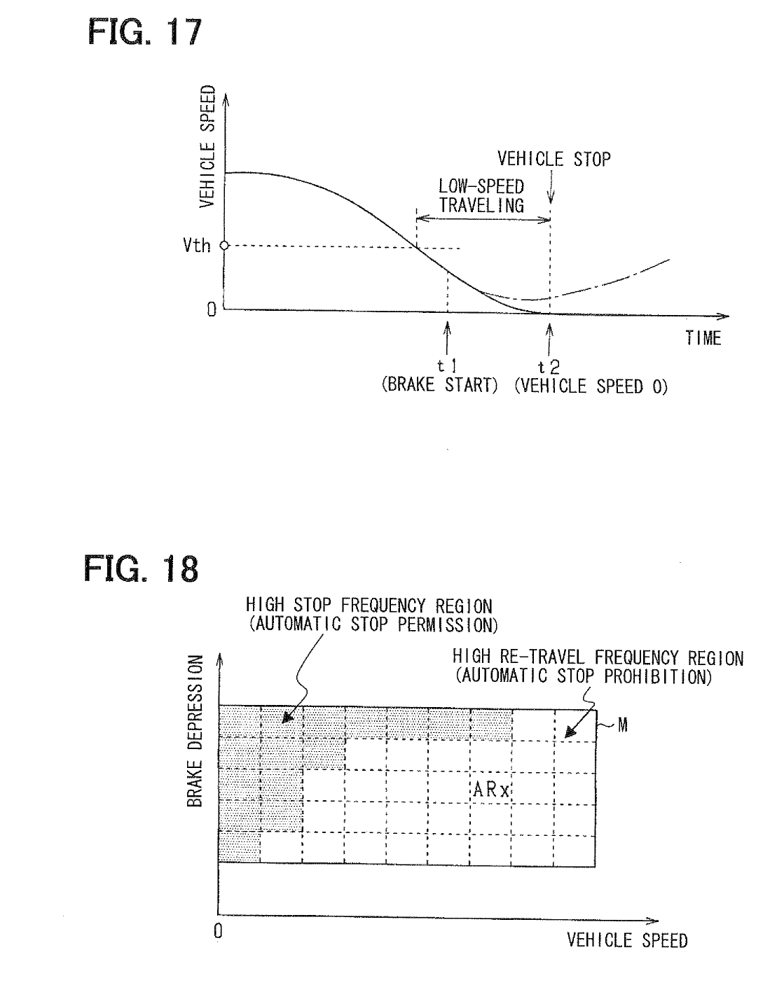

The solid line in FIG. 17 shows an example in which an actual vehicle speed first becomes less than or equal to a predetermined vehicle speed Vth to shift the present state to the low-speed traveling state. Subsequently, a driver first depresses the brake device at the time point t1. Thereafter, the vehicle stops at the time point t2. The dashed dotted line in FIG. 17 shows an example in which a driver of the vehicle first depresses the brake device at the time point t1. Thereafter, the driver depresses the accelerator pedal 39 to increase the vehicle speed. Consequently, the vehicle does not result in stop in this case.

The ECU 44 includes a rewritable storage media (memory device). The ECU 44 causes the storage media to store a data map M shown in FIG. 18. The data map M has axes of the brake depression quantity and the vehicle speed. The data map M includes multiple regions ARx divided for each brake depression quantity region and each vehicle speed region. Each region ARx stores a stop frequency and a re-travel frequency described later. The ECU 44 learns the stop frequency and the re-travel frequency and updates the stored stop frequency and re-travel frequency. As shown by the solid line in FIG. 17, the stop frequency is a frequency of occurrence of a state in which a driver depresses the brake device in a low-speed traveling state to result in stop of the vehicle. As shown by the dashed dotted line in FIG. 17, the re-travel frequency is a frequency of occurrence of a state in which a driver depresses the brake device in a low-speed traveling state, and thereafter an intention (traveling continuation intention) of the driver to continue traveling without stopping the vehicle is detected, thereby to result in non-stop of the vehicle. In the shaded regions in FIG. 18, the stop frequency is higher than the re-travel frequency. In the non-shaded regions in FIG. 18, the re-travel frequency is higher than the stop frequency.

Specifically, the traveling continuation intention is detected when increase (acceleration) in the vehicle speed is detected after the time point t1, when depression of the accelerator pedal 39 is detected after the time point t1, or when a manipulation quantity (steering angle) of the steering handle greater than or equal to a predetermined quantity is detected after the time point t1, for example.

The ECU 44 performs the learning operation for each driver. Specifically, for example, a driver may manipulate a selection switch device 19 (FIG. 16) provided in the vehicle interior to cause the ECU 44 to identify the driver. The ECU 44 stores the data map M for each driver, and selects one data map M on instruction to identify a driver caused by manipulation of the selection switch device 19. The ECU 44 learns the contents for the selected data map M.

Thus, using the data map M learned in this way, the ECU 44 determines whether to perform the automatic engine stop, as described below. Specifically, when a driver depresses the brake pedal 31 in a low-speed traveling state and when the region ARx corresponding to the brake depression quantity and the vehicle speed at the time point t1 is in the shaded region in FIG. 18 where the stop frequency is high in data map M, automatic stop of the engine 10 is permitted. When another automatic stop condition is satisfied in the low-speed traveling state, the engine 10 is stopped automatically even before the vehicle stops.

The presently described other automatic stop condition is satisfied when a driver does not have an intention to continue to travel the vehicle, mainly. Specifically, the other automatic stop condition is satisfied when the driver does not depress the accelerator pedal 39, the vehicle speed does not increase, i.e., the vehicle does not accelerate, manipulation (steering angle) of the steering handle is not greater than or equal to a predetermined degree, for example.

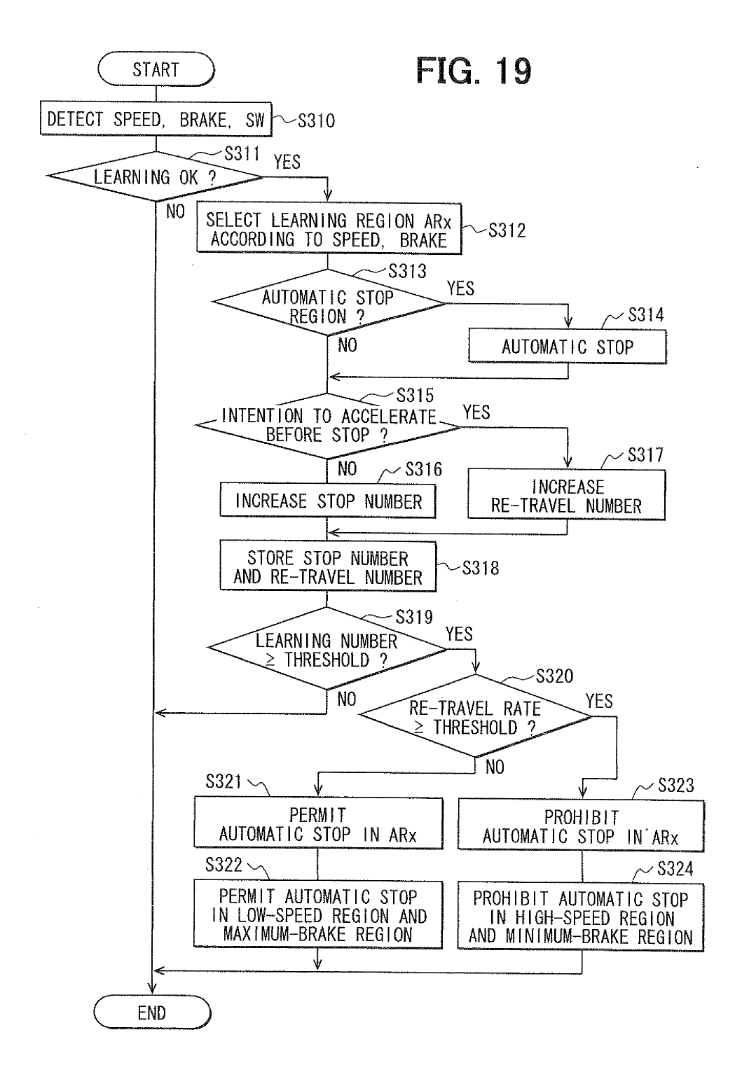

FIG. 19 is a flow chart showing a procedure of the learning operation and the automatic stop operation executed by the microcomputer of the ECU 44. The present operations are repeatedly executed at predetermined cycles.

First, at step S310 of FIG. 19, the ECU 44 obtains a present vehicle speed, a brake depression quantity, and driver information according to detection signals outputted from the vehicle speed sensor 15, the brake sensor 33, and the selection switch device 19. At subsequent step S311, it is determined whether the learning condition is satisfied to enable execution of the learning operation of the data map M. In the present embodiment, the learning condition is satisfied when at least one of the following conditions is satisfied: the vehicle speed is less than or equal to the predetermined vehicle speed Vth and the vehicle is in a low-speed traveling state; a driver does not have an intention to continue to travel the vehicle; and a driver continues to depress the brake pedal 31 for a predetermined time or longer. When the learning condition is not satisfied, it is determined that the learning operation cannot be executed (S311: NO). In this case, the operation of FIG. 19 is once terminated.

When the learning condition is satisfied (S311: YES), it is determined that the learning operation can be executed. In this case, at subsequent step S312, a target data map M corresponding to a target driver is selected according to the driver information obtained at step S310. Further, one region ARx corresponding to the vehicle speed and the depression quantity obtained at step S310 is selected from the data map M, and the selected one region ARx is determined to be the learning region ARx.

At subsequent step S313 (determination unit), it is determined whether the learned content in the region determined at step S312 is an automatic stop regions described later. When the learned content is determined to be the automatic stop region (S313: YES), the automatic engine stop is permitted. At subsequent step S314, when the automatic stop condition is also satisfied, the ECU 44 controls the fuel injection valve to stop fuel injection from the fuel injection valve so as to stop the engine 10 automatically, even when the vehicle is in a low-speed traveling state. When it is determined not to be in the automatic stop region (S313: NO), at subsequent step S315, it is determined whether an intention to continue to travel the vehicle is detected. Specifically, when a driver has an intention to accelerate the vehicle, an intention to continue to travel the vehicle is determined to be detected.

When it is determined that a driver does not have an intention to continue to travel the vehicle (S315: NO), the processing proceeds to subsequent step S316. At step S316, the ECU 44 increases a number of cases where the vehicle results in stop (vehicle speed=0) due to depression of the brake device obtained at step S310. In addition, at subsequent step S318 (learning unit), the ECU 44 performs the learning operation to increase the stop frequency. When it is determined that a driver has an intention to continue to travel the vehicle (S315: YES), the processing proceeds to subsequent step S317. At step S317, the ECU 44 increases a number of cases where the vehicle does not result in stop (vehicle speed≠0) due to depression of the brake device obtained at step S310. In addition, at subsequent step S318 (learning unit), the ECU 44 performs the learning operation to increase the re-travel frequency.

At subsequent step S319, when it is determined that the number of learning in the learned region is greater than or equal to a predetermined number (S319: YES), the processing proceeds to step S320. At step S320, when the number of re-travel counted at step S318 is greater than the number of stop, a re-travel rate (frequency) is greater than a predetermined number (S320: YES). In this case, the corresponding region ARx is set to be an automatic stop prohibition region (S323). Alternatively, when the number of re-travel is less than the number of stop, the re-travel rate (frequency) is less than the predetermined number (S320: NO). In this case, the corresponding region ARx is set to be an automatic stop region (S321).

The depression quantity and the vehicle speed in a region, which is set to be the automatic stop region at step S321, are a stop depression quantity and a stop vehicle speed. The depression quantity and the vehicle speed in a region, which is set to be the automatic stop prohibition region at step S323, are a non-stop depression quantity and a non-stop vehicle speed. At step S322 subsequent to step S321, an unlearned region, in which the depression quantity is greater than or equal to the stop depression quantity and the vehicle speed is less than or equal to the stop vehicle speed, and a region, in which the number of learning is less than a predetermined number, are set to be an automatic stop region to permit automatic stop. At step S324 subsequent to step S322, an unlearned region, in which the depression quantity is less than or equal to the non-stop depression quantity and the vehicle speed is greater than or equal to the non-stop vehicle speed, and a region, in which the number of learning is less than a predetermined number, are set to be an automatic stop prohibition region to prohibit automatic stop.

In an unset region, which is not set to be the automatic stop region or the automatic stop prohibition region at step S321, S322, S323, or S324, determination at step S313 is performed according to an initial configuration. For example, an initial configuration is made such that the shaded region in FIG. 18 is set to be an automatic stop region, and the non-shaded region is set to be an automatic stop prohibition region.

As described above, according to the present embodiment, when the brake pedal 31 is depressed in a low-speed traveling state, the depression quantity, the vehicle speed at the depression time point, and the result whether the depression causes the vehicle to result in stop are associated and learned to update the data map M. In addition, it is determined whether to perform automatic engine stop in the low-speed traveling state according to the learning result. Therefore, determination of automatic engine stop in a low-speed traveling state is enabled not to cause uncomfortable feeling caused by non-automatic engine stop due to insufficient depression quantity contrary to depression of the brake pedal 31 with an intention to stop the vehicle. In addition, determination of automatic engine stop in a low-speed traveling state is enabled not to cause uncomfortable feeling caused by automatic engine stop contrary to depression of the brake pedal 31 to decrease the vehicle speed without an intention to stop the vehicle.

Further, in the present embodiment, the learning is performed with the different data maps M each defined for each driver. Therefore, determination of automatic engine stop can be made according to a characteristic of each driver. Thus, uncomfortable feeling in driving the vehicle can be further removed.

Further, in the present embodiment, when an intension of a driver to accelerate the vehicle is detected after the driver depresses the brake pedal 31 in a low-speed traveling state until the vehicle results in stop, learning caused by the depression is prohibited. Therefore, it is avoidable to learn a stop result low in correlatively with the depression quantity and the vehicle speed.

Further, in the present embodiment, an unlearned region, in which the depression quantity is greater than or equal to the stop depression quantity and the vehicle speed is less than or equal to the stop vehicle speed, and a region in which the number of learning is less than a predetermined number are set to be the automatic stop region to permit automatic stop. Further, in the present embodiment, an unlearned region, in which the depression quantity is less than or equal to the non-stop depression quantity and the vehicle speed is greater than or equal to the non-stop vehicle speed, and a region in which the number of learning is less than a predetermined number are set to be the automatic stop prohibition region to prohibit automatic stop. Therefore, automatic engine stop determination can be made according to a characteristic of a driver, without waiting for completion of a predetermined number of learning.

### Other Embodiment

The present embodiment is not limited to that described above and may be modified as follows.

According to the present embodiment, the shaded region in FIG. 18 is set to be an automatic stop region in the initial configuration, and the non-shaded region is set to an automatic stop prohibition region in the initial configuration to define the data map M. It is noted that all the regions may be set to an automatic stop prohibition region in the initial configuration, or all the regions may be set to an automatic stop region in the initial configuration.

It is noted that a frequency whether the vehicle results in stop differs in dependence upon history of the vehicle speed until the vehicle results in the vehicle speed, even when the brake depression quantity and the vehicle speed at that time are the same. Specifically, there is a difference between a frequency whether the vehicle results in stop, when the vehicle quickly slows down to result in the predetermined vehicle speed Vth, and a frequency whether the vehicle results in stop, when the vehicle gradually slows down to result in the predetermined vehicle speed Vth. Therefore, in the determination at step S311 in FIG. 19 whether the learning condition is satisfied, a threshold for determining whether to learn may be changed according to a history of the vehicle speed. The threshold for determining whether to stop the engine automatically may be changed according to a history of the vehicle speed. The threshold for determining whether to stop the engine automatically may be learned for each history of the vehicle speed.

Summarizing the above embodiments, an idle stop control device for an idle-stop vehicle configured to automatically stop an engine before a vehicle speed becomes 0 when a brake pedal is depressed while traveling at a low speed less than or equal to a predetermined vehicle speed, the idle stop control device includes:

a learning unit configured to: associate a depression quantity of depression of the brake pedal and a vehicle speed of the vehicle at a time point when the brake pedal is depressed while the vehicle travels at a low speed with a result whether the vehicle results in stop due to the depression; and learn to obtain a learning result of the associated depression quantity and the vehicle speed with the result; and

a determination unit configured to determine whether to stop the engine automatically according to the learning result of the learning unit when the brake pedal is depressed while the vehicle travels at a low speed.

In this way, a depression quantity of depression of the brake pedal and a vehicle speed of the vehicle at a time point when the brake pedal is depressed while the vehicle travels at a low-speed are associated with a result whether the vehicle results in stop due to the depression. In addition, the associated depression quantity and the vehicle speed with the result are learned to obtain a learning result. In reality, it is conceived that a driver manipulates the depression quantity with reference to speed reduction caused by the brake device. Therefore, the depression quantity and the vehicle speed when depression is made with an intention to stop the vehicle are associated with the result in stop, and the associated contents are learned. Furthermore, the depression quantity and the vehicle speed when depression is made to decrease the vehicle speed without an intention to stop the vehicle is associated with the result in non-stop, and the associated contents are learned.

In the present embodiment, it is determined whether to stop the engine automatically according to the learned contents while the vehicle travels at a low speed. Therefore, determination of automatic stop of the engine is enabled not to cause uncomfortable feeling caused by no engine automatic stop due to insufficient depression quantity contrary to depression of the brake pedal with an intention to stop the vehicle. In addition, determination of automatic stop of the engine is enabled not to cause uncomfortable feeling caused by engine automatic stop contrary to depression of the brake pedal to decrease the vehicle speed without an intention to stop the vehicle.

When different results of stop or non-stop are made in the same region specified by the depression quantity and the vehicle speed, a frequency of result in stop and a frequency of result in non-stop may be calculated, and the result higher in the frequency may be learned.

The learning unit is configured to perform learning differently for each driver for the same vehicle.

Vehicles have different correlations between the brake depression quantity and speed reduction caused by the brake device. In addition, drivers have different characteristics in operation of the brake pedal even in the same vehicle. Therefore, drivers differently cause the depression quantity with an intension to stop the vehicle and the depression quantity to decrease the vehicle speed without an intension to stop the vehicle. Therefore, even when automatic stop determination is made without causing uncomfortable feeling in a certain driver, the same automatic stop determination may cause uncomfortable feeling in another driver.

In consideration of this, according to the present invention, the depression quantity and the vehicle speed are associated with the result in whether stop or non-stop when the brake pedal is depressed, and the associated contents are learned, in differently (separately) for each driver. Therefore, automatic stop determination can be made according to a characteristic of each driver. Thus, aforementioned concern can be avoided to enable automatic stop determination without causing uncomfortable feeling in a driver.

When an intension of a driver to accelerate the vehicle is detected after the brake pedal is depressed while the vehicle travels at a low speed until the vehicle results in stop, learning accompanied by the depression is prohibited.

A driver may show an intention to accelerate the vehicle by, for example, depressing the accelerator pedal, after depressing the brake pedal while traveling the vehicle at a low speed. In this case, even when the vehicle results in stop after the driver shows an intention to accelerate the vehicle, correlatively between the depression quantity and the vehicle speed when the depression is made and the result in stop is significantly low.

In consideration of this, according to the present invention, when an intension of a driver to accelerate the vehicle is detected, after the driver depresses the brake pedal while traveling the vehicle at a low speed, until the vehicle results in stop, learning accompanied with the depression is prohibited. Therefore, it is avoidable to learn a result in stop, which is low in correlatively.

The depression quantity and the vehicle speed in a region, in which a result in stop is learned, are a stop depression quantity and a stop vehicle speed. The determination unit is configured to determine to automatically stop the engine in an unlearned region in which the depression quantity is greater than or equal to the stop depression quantity and the vehicle speed is less than or equal to the stop vehicle speed.

Even in an unlearned region, a driver may have an intension to stop the vehicle with high possibility, when the depression quantity in the unlearned region is greater than or equal to a depression quantity in a region in which the vehicle results in stop and when the vehicle speed in the unlearned region is less than or equal to a vehicle speed in a region in which the vehicle results in stop. Therefore, in such an unlearned region, it is determined to stop the engine automatically. In consideration of this, in the present embodiment, it is determined to stop the engine automatically in such an unlearned region. In this way, automatic stop determination can be appropriately made at an early stage before completion of learning in all the regions.

The depression quantity and the vehicle speed in a region, in which a result in non-stop is learned, are a non-stop depression quantity and a non-stop vehicle speed. The determination unit is configured to determine not to stop the engine automatically in an unlearned region in which the depression quantity is less than or equal to the non-stop depression quantity and the vehicle speed is greater than or equal to the non-stop vehicle speed.

Even in an unlearned region, a driver may not have an intension to stop the vehicle with high possibility, when the depression quantity in the unlearned region is greater than or equal to a depression quantity in a region in which the vehicle results in non-stop and when the vehicle speed in the unlearned region is less than or equal to a vehicle speed in a region in which the vehicle results in non-stop. Therefore, in such an unlearned region, it is determined not to stop the engine automatically. In consideration of this, in the present embodiment, it is determined not to stop the engine automatically in such an unlearned region. In this way, automatic stop determination can be appropriately made at an early stage before completion of learning in all the regions.

The above structures of the embodiments can be combined as appropriate.

The above processings such as calculations and determinations are not limited being executed by the ECU 42, the ECU 43, or the ECU 44. The control unit may have various structures including the ECU 42, the ECU 43, or the ECU 44 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partiality or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A control device for an internal combustion engine for a vehicle having a steering device for steering a steering wheel of the vehicle, the control device comprising:
a control unit configured to perform an automatic stop operation and a restart operation of the internal combustion engine; and
a prohibition unit configured to prohibit the automatic stop operation according to transition of a steering degree of the steering device while the vehicle travels.

2. The control device according to claim 1, wherein the automatic stop operation is configured to be permitted while the vehicle travels.

3. The control device according to claim 2, further comprising:
a change angle arithmetic unit configured to calculate a vehicle direction change angle as the transition of the steering degree, the vehicle direction change angle being an integration value of an angle between a straight-ahead direction of the vehicle and an actual traveling direction of the vehicle at each time, wherein
the prohibition unit is further configured to prohibit the automatic stop operation according to the calculated vehicle direction change angle.

4. The control device according to claim 3, further comprising:
a storage unit configured to store information on an operation region in which the automatic stop operation is prohibited, the operation region being associated with the vehicle direction change angle, wherein
the prohibition unit is further configured to prohibit the automatic stop operation according to the vehicle direction change angle in the operation region.

5. The control device according to claim 4, wherein the operation region is associated with both the steering degree of the steering device and the vehicle direction change angle.

6. The control device according to claim 3, wherein the change angle arithmetic unit is further configured to calculate the vehicle direction change angle according to:
the traveling speed of the vehicle; and
one of the steering degree of the steering device and the wheel angle of the steering wheel.

7. The control device according to claim 3, further comprising:
a reset unit configured to reset the vehicle direction change angle when the steering degree of the steering device is continually less than or equal to a predetermined value for a predetermined time period.

8. The control device according to claim 1, further comprising:
a unit configured to prohibit the automatic stop operation when the steering degree of the steering device becomes greater than a predetermined value, wherein
the prohibition unit is further configured to prohibit the automatic stop operation in a time period from a first time point to a second time point,
at the first time point, the steering degree of the steering device as the transition becomes less than or equal to the predetermined value, and
at the second time point, it is determined that the vehicle travels straight ahead for a predetermined time period according to the steering degree from the first time point.

9. The control device according to claim 8, wherein the predetermined time period is at least one of:
a time period from the first time point to a time point at which a travel distance of the vehicle becomes greater than or equal to a predetermined distance; and
a time period from the first time point to a time point at which a traveling speed of the vehicle becomes greater than or equal to a predetermined speed.

10. The control device according to claim 2, further comprising:
a unit configured to calculate a change rate of the steering degree according to the transition of the steering degree, wherein
the prohibition unit is further configured to prohibit the automatic stop operation when the calculated change rate becomes greater than or equal to a predetermined rate.

11. The control device according to claim 10, further comprising;
a unit configured to prohibit the automatic stop operation when the steering degree of the steering device becomes greater than a predetermined degree.

12. A control device for an internal combustion engine of a vehicle, the method comprising:
a control unit configured to perform an operation to stop the internal combustion engine automatically while the vehicle travels;
a vehicle braking force arithmetic unit configured to calculate a vehicle braking force, which is a resultant force of an acceleration force and a deceleration force, the acceleration force working in an acceleration direction to accelerate the vehicle, the deceleration force working in a deceleration direction to decelerate the vehicle, the deceleration force including a braking force of a brake device of the vehicle, the vehicle braking force has a positive value when working in the deceleration direction to decelerate the vehicle; and
a prediction unit configured to predict whether the vehicle stops according to the calculated vehicle braking force and a traveling speed of the vehicle, wherein
the control unit is further configured to perform the operation to stop the internal combustion engine automatically according to a prediction that the vehicle stops.

13. The control device according to claim 12, wherein the vehicle braking force arithmetic unit is further configured to calculate the vehicle braking force according to at least one of the braking force of the brake device, a travel resistance working on the vehicle, and an output torque of the internal combustion engine, the travel resistance including a slope resistance working on the vehicle.

14. The control device according to claim 12, further comprising:
a first setting unit configured to variably set a first threshold for the vehicle braking force according to the traveling speed of the vehicle; and
a second setting unit configured to set a second threshold for the vehicle braking force, the second threshold being a value less than the first threshold, wherein
the prediction unit is further configured to predict that the vehicle stops when the vehicle braking force becomes greater than the first threshold, and
the control unit is further configured to perform an operation to restart the internal combustion engine when the vehicle braking force becomes less than or equal to the second threshold in a condition where the internal combustion engine is automatically stopped.

15. The control device according to claim 14, further comprising:
a restart regulating unit configured to impose regulation on activation of the operation to restart the internal combustion engine for a predetermined period on determination that it is immediately before stop of the vehicle in a condition where the internal combustion engine is automatically stopped.

16. The control device according to claim 15, wherein the restart regulating unit is further configured to decrease the second threshold for a predetermined period so as to impose the regulation on activation of the operation to restart the internal combustion engine.

17. The control device according to claim 14, further comprising:
an automatic stop regulation unit configured to impose regulation on activation of the operation to stop the internal combustion engine automatically, after restart of the internal combustion engine until the traveling speed of the vehicle becomes greater than or equal to a predetermined speed.

18. The control device according to claim 17, wherein the automatic stop regulation unit is further configured to increase the first threshold until the traveling speed of the vehicle becomes greater than or equal to the predetermined speed so as to impose the regulation on activation of the operation to stop the internal combustion engine automatically.

19. A control device for an internal combustion engine of a vehicle, the vehicle configured to automatically stop the internal combustion engine before a speed of the vehicle becomes 0 when a brake pedal is depressed while the vehicle travels at a low speed less than or equal to a predetermined speed, the control device control device comprising:
a learning unit configured to:
associate a depression quantity of a brake pedal of the vehicle and a speed of the vehicle at a time point, when the brake pedal is depressed while the vehicle travels at a low-speed, with a result whether the vehicle results in stop due to depression of the brake pedal; and
learn the associated depression quantity and the speed with the result to obtain a learning result; and
a determination unit configured to determine whether to stop the internal combustion engine automatically according to the learning result of the learning unit when the brake pedal is depressed while the vehicle travels at a low speed.

20. The idle stop control device according to claim 19, wherein the learning unit is further configured to perform learning differently for each driver for the same vehicle.

21. The idle stop control device according to claim 19, wherein in a condition where an intension of a driver to accelerate the vehicle is detected from when the brake pedal is depressed while the vehicle travels at a low speed to when the vehicle results in stop, learning resulting from the depression is prohibited.

22. The idle stop control device according to claim 19, wherein
the depression quantity and the speed of the vehicle are respectively a stop depression quantity and a stop speed in a region, in which the vehicle resulting in stop is learned, and
the determination unit is further configured to determine to stop the internal combustion engine automatically in an unlearned region in which the depression quantity is greater than or equal to the stop depression quantity and the speed of the vehicle is less than or equal to the stop speed.

23. The idle stop control device according to claim 19, wherein
the depression quantity and the speed of the vehicle are respectively a non-stop depression quantity and a non-stop speed in a region, in which the vehicle resulting in non-stop is learned, and
the determination unit is further configured to determine not to stop the internal combustion engine automatically in an unlearned region in which the depression quantity is less than or equal to the non-stop depression quantity and the speed of the vehicle is greater than or equal to the non-stop speed.

24. A method for controlling an internal combustion engine for a vehicle, the vehicle configured to perform an automatic stop operation and a restart operation of an internal combustion engine, the vehicle having a steering device for steering a steering wheel of the vehicle, the method comprising:
detecting a steering degree of the steering device; and
prohibiting the automatic stop operation according to a transition of the detected steering degree of the steering device while the vehicle travels.

25. A method for controlling an internal combustion engine of a vehicle, the method comprising:
calculating a vehicle braking force, which is a resultant force of an acceleration force and a deceleration force, the acceleration force working in an acceleration direction to accelerate the vehicle, the deceleration force working in a deceleration direction to decelerate the vehicle, the deceleration force including a braking force of a brake device of the vehicle, the vehicle braking force having a positive value when working in the deceleration direction;
predicting whether the vehicle stops according to the calculated vehicle braking force and a traveling speed of the vehicle; and
stopping the internal combustion engine automatically while the vehicle travels according to a prediction that the vehicle stops.

26. A method for controlling an internal combustion engine of a vehicle, the method comprising:
associating a depression quantity of a brake pedal of the vehicle and a speed of the vehicle at a time point, when the brake pedal is depressed while the vehicle travels at a low-speed, with a result whether the vehicle results in stop due to depression of the brake pedal;
learning the associated depression quantity and the speed with the result to obtain a learning result;
determining whether to stop the internal combustion engine automatically, when the brake pedal is depressed while the vehicle travels at a low speed less than or equal to a predetermined speed, according to the learning result to obtain a determination result; and
stopping the internal combustion engine automatically before the speed becomes 0, according to the determination result.

27. A computer readable medium comprising instructions executed by a computer, the instructions including the method according to claim 24.

28. A computer readable medium comprising instructions executed by a computer, the instructions including the method according to claim 25.

29. A computer readable medium comprising instructions executed by a computer, the instructions including the method according to claim 26.
